(19) United States
(12) Patent Application Publication
(10) Pub. No.: US 2024/0370000 A1
(43) Pub. Date: Nov. 7, 2024

(54) INTELLIGENT SCHEDULING METHOD AND SYSTEM AND NON-TRANSITORY COMPUTER-READABLE RECORDING MEDIUM

(71) Applicant: Wistron Corporation, New Taipei City (TW)

(72) Inventors: Min-Chih Hsueh, New Taipei City (TW); Guan-He Wu, New Taipei City (TW); Hsien-Hung Shih, New Taipei City (TW)

(73) Assignee: Wistron Corporation, New Taipei City (TW)

(21) Appl. No.: 18/341,773

(22) Filed: Jun. 27, 2023

(30) Foreign Application Priority Data
Apr. 25, 2023 (TW) 112115409

(51) Int. Cl. G05B 19/418

(52) U.S. Cl. CPC G05B 19/41865; G05B 19/4185; G05B 19/41885

(57) ABSTRACT

Disclosed are an intelligent scheduling method and system. The intelligent scheduling method includes the following steps. A work order assignment module is used to assign multiple work orders to one of multiple production lines respectively. A work order form batching module is used to perform a form batch for the work orders assigned to each production line, so that the work orders are divided into multiple work order groups. A work order detailed scheduling module is used to solve for each work order included in each batch of each production line to obtain a schedule plan, wherein the schedule plan includes an assigned production line of each work order and an operation sequence. The schedule plan is sent to an output device.

### CROSS-REFERENCE TO RELATED APPLICATION

This application claims the priority benefit of Taiwan application serial no. 112115409, filed on Apr. 25, 2023. The entirety of the above-mentioned patent application is hereby incorporated by reference herein and made a part of this specification.

### BACKGROUND

### Field of the Disclosure

The present disclosure relates to a scheduling mechanism, and in particular to an intelligent scheduling method and system and a non-transitory computer-readable recording medium.

### Description of Related Art

Electronic manufacturing service industry is customer-oriented, and good production cost control and operation schedule planning are the key issues in improving the efficiency and service level of the production system. Production scheduling is a highly complex issue related to optimization of combination, and the main decisions include work order production allocation and operation sequencing. Production allocation is mainly related to how to assign work orders to appropriate production lines, and operation sequencing mainly determines the beginning and completion time of operations of various work orders to achieve specific scheduling performance indicators. As the problem becomes more complex, there may be tens of millions of possible combinations for scheduling. Therefore, it is extremely difficult to find a nearly optimal schedule plan within a reasonable time, and it is a problem to be solved by enterprises.

### SUMMARY OF THE DISCLOSURE

The present disclosure provides an intelligent scheduling method and system, which are able to plan a set of optimal or near-optimal desired production schedule plans within a reasonable time.

The intelligent scheduling method of the present disclosure utilizes a processor to execute a work order assignment module, a work order form batching module and a work order detailed scheduling module, and the intelligent scheduling method includes the following steps: A. assigning multiple work orders to one of the multiple lines respectively through the work order assignment module; B. performing a form batch for the work orders assigned to each production line through the work order form batching module, so that the work orders are divided into multiple work order groups; C. solving for each work order included in each batch of each production line through the work order detailed scheduling module to obtain a schedule plan, and the schedule plan includes a production line assigned for each work order and a operation sequence; and D. transmitting the schedule plan to the output device.

The intelligent scheduling system of the present disclosure includes a storage, an output device, and a processor. The memory stores a work order assignment module, a work order form batching module and a work order detailed scheduling module. The processor is coupled to the storage and the output device, and is configured to perform steps A to D.

Based on the above, this disclosure takes into consideration the limitations in actual conditions such as manufacturing resources and practical operations, and integrates optimization objective function planning to achieve the requirements of enterprises on the overall production system performance and service level. In addition, designing a parameter evaluation model and applying the model to the work order assignment module not only may effectively improve the solution efficiency of the system, but also provides an intelligent automatic parameter value adjustment function for users' reference to set the optimal work order assignment plan.

### BRIEF DESCRIPTION OF THE DRAWINGS

FIG. 1 is a block diagram of an intelligent scheduling system according to an embodiment of the present disclosure.

FIG. 2 is a block diagram of a scheduling architecture according to an embodiment of the present disclosure.

FIG. 3 is a flowchart of an intelligent scheduling method according to an embodiment of the present disclosure.

FIG. 4 is a flowchart of an adaptive algorithm according to an embodiment of the present disclosure.

FIG. 5A to FIG. 5G are schematic diagrams of scheduling-related data according to an embodiment of the present disclosure.

FIG. 6A and FIG. 6B are schematic diagrams of a user interface according to an embodiment of the present disclosure.

FIG. 7 is a schematic diagram of work order assignment report data according to an embodiment of the present disclosure.

FIG. 8A to FIG. 8C are schematic diagrams of form batching-related data according to an embodiment of the present disclosure.

FIG. 9 is a schematic diagram of work order form batching report data according to an embodiment of the present disclosure.

FIG. 10A to FIG. 10G are schematic diagrams of detailed scheduling data according to an embodiment of the present disclosure.

FIG. 11A and FIG. 11B are schematic diagrams of scheduling report data according to an embodiment of the present disclosure.

### DESCRIPTION OF EMBODIMENTS

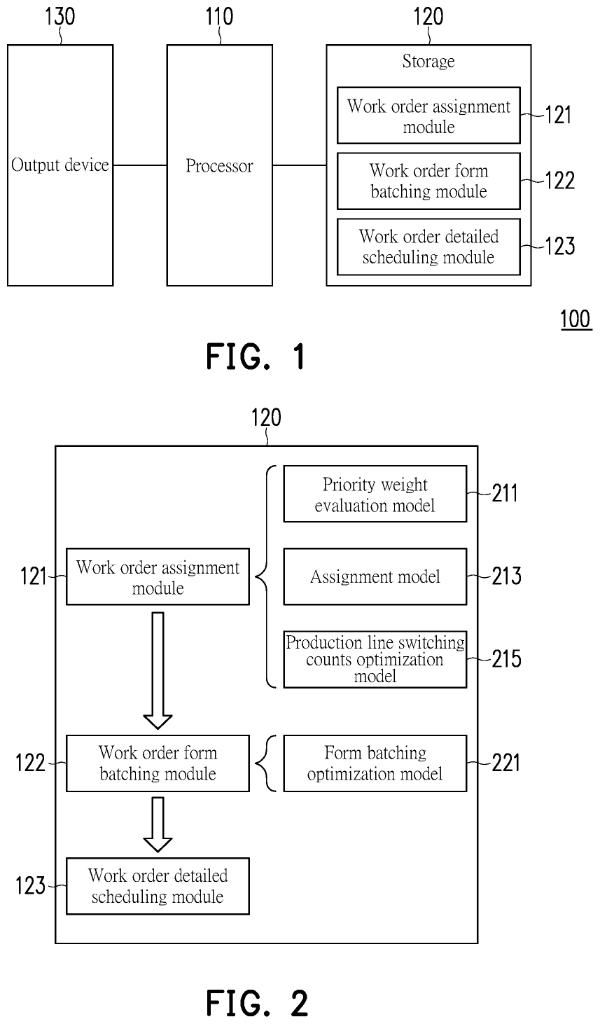

FIG. 1 is a block diagram of an intelligent scheduling system according to an embodiment of the present disclosure. Please refer to FIG. 1, the intelligent scheduling system 100 includes a processor 110, a storage 120 and an output device 130. The processor 110 is coupled to the storage 120 and the output device 130. The storage 120 includes a work order assignment module 121, a work order form batching module 122 and a work order detailed scheduling module 123.

In an embodiment, the intelligent scheduling system 100 may be implemented by using electronic devices with computing functions such as servers, personal computers, notebook computers, tablet computers, and mobile devices. In another embodiment, the intelligent scheduling system 100 may also be realized by using two electronic devices, one of which is loaded with the processor 110, and the other is loaded with the storage 120.

The processor 110 is, for example, a central processing unit (CPU), a physics processing unit (PPU), a programmable microprocessor, an embedded control chip, a digital signal processor (DSP), an application specific integrated circuit (ASIC) or other similar devices.

The storage 120 is, for example, any type of fixed or removable random access memory (RAM), read-only memory (ROM), flash memory, hard disk or other similar device or a combination of these devices. The work order assignment module 121, the work order form batching module 122 and the work order detailed scheduling module 123 are composed of one or more code fragments, and the above code fragments will be executed by the processor 110 after being installed.

The output device 130 is, for example, a display device, a printer, and the like. The processor 110 transmits the scheduling result to the output device 130 for output or presentation through the output device 130. For example, the scheduling results are displayed on the display device, or the scheduling results are printed as paper reports. The display device is, for example, a liquid crystal display (LCD), a plasma display, and the like.

In an embodiment, the intelligent scheduling system 100 is constructed by combining the functional constraints of the mathematical model with the setting of the optimization objective function along with the use of a heuristic algorithm. The intelligent scheduling system 100 is able to help enterprises solve the problem of work order scheduling, and ensure that system users are able to find the optimal or near-optimal ideal production schedule plan within a reasonable time to effectively meet clients' needs and satisfy order-related requirement.

The work order assignment module 121 takes into consideration the suitability for production line and the limitations such as available capacity and fixtures, and utilizes the integer programming model to determine the production line assignment for work order, so as to assign each work order to an appropriate production line.

The work order form batching module 122 includes a form batching optimization model 221, which is utilized to construct a binary integer programming model by taking into consideration limitations such as production line material preparation mode and batch limit according to attributes such as work order type, main substitute material, material station relationship, and operation methods, thereby solving the work order form batching strategy corresponding to various production lines. By using the work order form batching module 122 to perform form batching for multiple work orders assigned to various production lines, it is possible to divide these work orders into multiple work order groups.

The work order detailed scheduling module 123 uses an ant colony optimization (ACO) algorithm to carry out work order detailed schedule plan, with the goal of maximizing the completion rate of the total weighted work order. During the execution of the ACO algorithm, a preset parameter may be dynamically adjusted according to the results of each iteration, so that the search behavior may achieve a balance between breadth and depth, and avoid premature convergence to the local optimum. The work order detailed scheduling module 123 performs planning and solving for each work order included in each batch on each production line to obtain a schedule plan. The schedule plan includes the assigned production line of each work order and its operation sequence (scheduled start time and scheduled completion time).

In an embodiment, the work order assignment module 121 utilizes integer programming (IP) to construct a priority weight evaluation model 211, an assignment model 213, and a production line switching counts optimization model 215, as shown in FIG. 2. FIG. 2 is a block diagram of a scheduling architecture according to an embodiment of the disclosure. In this embodiment, the priority weight evaluation model 211 and the production line switching counts optimization model 215 are designed based on the assignment model 213.

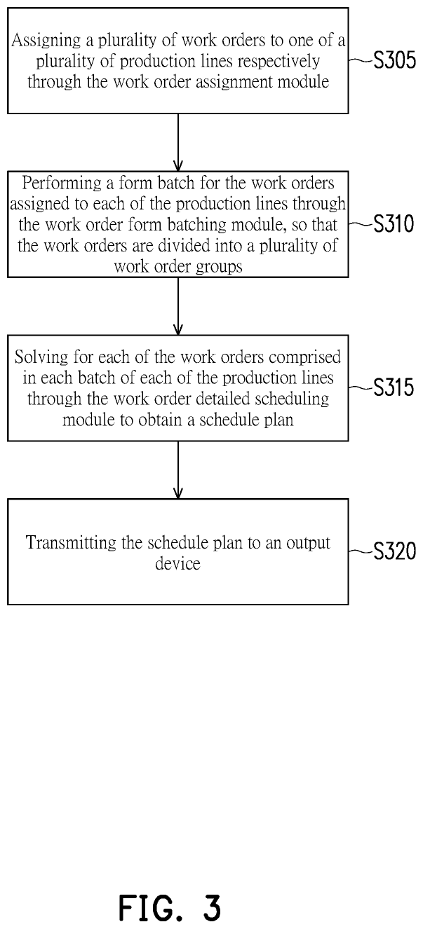

FIG. 3 is a flowchart of an intelligent scheduling method according to an embodiment of the present disclosure. Referring to FIG. 3, in step S305, through the work order assignment module 121, multiple work orders are assigned to one of the multiple production lines. Next, in step S310, through the work order form batching module 122, form batching is performed for the multiple work orders assigned to each production line, so as to divide the work orders into multiple work order groups. In step S315, the work order detailed scheduling module 123 is utilized to solve each work order included in each batch of each production line to obtain a schedule plan. Here, the schedule plan includes the production line assigned for each work order and the operation sequence (scheduled start time and scheduled completion time). Afterwards, in step S320, the schedule plan is transmitted to the output device 130. For example, the schedule plan is displayed on a display device, or the schedule plan is printed to a physical paper.

The following examples are given to facilitate description in details. In the following embodiments, n represents the total number of work orders, m represents the total number of production lines used to produce the work orders, and O represents the total number of model sets with the same standard operating procedures (SOP), i represents the serial number of work orders, j represents the serial number of production line used to produce the work order, o represents the serial number of the model set with the same SOP, p represents the serial number of the model, and w represents the right type of the work order. The value range limitation of work order variables is shown in formula (C1)˜formula (C3).

$${x}_{ij} ∈ \{ 0 , 1 \} , i = 1 , 2 , .. , n , j ∈ {LES}_{i} \qquad ( C1 )$$

$${φ}_{oj} ∈ \{ 0 , 1 \} , o = 1 , 2 , ... , O , j ∈ {LSS}_{o} \qquad ( C2 )$$

$${u}_{j} ∈ \{ 0 , 1 \} , j = 1 , 2 , ... , m \qquad ( C3 )$$

In the formula (C1), xᵢⱼ is used to indicate whether the work order i is assigned to the production line j. If the work order i has been assigned to the production line j, xᵢⱼ=1; otherwise, xᵢⱼ=0. LESᵢ is a production line set capable of producing work order i. In formula (C2), φₒⱼ represents whether the model set o is assigned to the production line j, if the model set o is assigned to the production line j, φₒⱼ=1; otherwise, φₒⱼ=0. LSSₒ is the production line set corresponding to the model set o. In formula (C3), uⱼ represents whether the production line j has been assigned with a model set, if the production line j has been assigned with a model set, uⱼ=1; otherwise, uⱼ=0.

The assignment model 213 is configured to: based on the first objective function, in the case of satisfying a plurality of first limiting conditions, assign each work order in the priority work order weight set to one of the production lines, and obtain the priority work order assignment plan.

The first objective function is configured to maximize a total weighted work order assignment quantity, as shown in formula (T1).

$$Max {\sum }_{i = 1}^{n} {\sum }_{j ∈ {LES}_{i}} {WTD}_{i} \cdot {x}_{ij} \qquad ( T1 )$$

In formula (T1), WTDᵢ represents the weight of work order i. Formula (T1) may be able to help the user quickly obtain the work order assignment plan with the optimal weight combination under the satisfaction of various work order assignment constraints (the first constraint conditions 1-1 to 1-7).

The first limiting condition 1-1 limits that each work order whose weight satisfying the priority work order weight set CWS is assigned to a production line as shown in formulas (1) and (2).

$${\sum }_{j ∈ {LES}_{i}} {x}_{ij} \leq 1 , i = 1 , 2 , ... , n \qquad ( 1 )$$

$${\sum }_{j = 1}^{m} {\sum }_{i ∈ {WMS}_{w} ⋂ {MLS}_{j}} {x}_{ij} \geq \vert {WMS}_{w} \vert , w ∈ CWS \qquad ( 2 )$$

Formula (1) limits that each work order i (i=1, 2, . . . ,n) can only be assigned to at most one production line j(j∈LESᵢ) for production. Formula (2) shows that all work orders i(i∈WMS_{w}∩MLSⱼ, WMS_{w} is the work order set corresponding to weight w, MLSⱼ is the work order set that may be produced on the production line j) corresponding to the weight w(w∈CWS) belonging to the priority work order weight set CWS need to be assigned. In practice, the priority work order weight set CWS may be strategically and dynamically adjusted. By using formula (2), it is possible to ensure that all work orders i with weight w may be assigned to the appropriate production line for production, so that the schedule plan conforms to planning logic and is flexible.

The first limiting condition 1-2 is provided to limit the upper and lower limits of the number of model sets o assigned to each production line j, as shown in formulas (3)-(5). SLSⱼ is a set composed of the numbers of the model sets corresponding to production line j, CLS is a set of unit production line, TCH is the upper limit of the production line switching counts for each production line, and M is a maximum positive value.

$${\sum }_{o ∈ {SLS}_{j}} {φ}_{oj} \geq {u}_{j} , j = 1 , 2 , ... , m \qquad ( 3 )$$

$${\sum }_{o ∈ {SLS}_{j}} {φ}_{oj} \leq ( TCH + 1 ) \cdot {u}_{j} , j ∈ \{ 1 , 2 , ... , m \} \backslash CLS \qquad ( 4 )$$

$${\sum }_{o ∈ {SLS}_{j}} {φ}_{oj} \leq M \cdot {u}_{j} , j ∈ CLS \qquad ( 5 )$$

Formulas (3) and (4) show that if the standard production line je {1, 2, . . . , m} \CLS assigns a model set (uⱼ=1), the corresponding upper and lower limits of the number of assigned model sets are 1≤Σ_{o∈SLS}_{ⱼ}φₒⱼ≤TCH+1; otherwise, Σ_{o∈SLS}_{ⱼ}φₒⱼ=0. The upper limit of Σ_{o∈SLS}_{ⱼ}φₒⱼ is TCH+1 because standard production lines need to be switched to produce different models. Formulas (3) and (5) show that if the unit production line j∈CLS assigns a model set (uⱼ=1), because there is no need to take into consideration the counts of switching unit production lines, the upper and lower limits of the corresponding assigned model set number are 1≤Σ_{o∈SLS}_{ⱼ}φₒⱼ≤M; otherwise, Σ_{o∈SLS}_{ⱼ}φₒⱼ=0. In practice, line switching operations will lead to loss of production capacity. By using this constraint formula, it is possible to establish the rationality of schedule plan and improve the utilization rate of production capacity.

The first limiting condition 1-3 is directed at each model set o assigned to each production line j, and limits upper and lower limits of the number of work orders that simultaneously exist in a work order set corresponding to each model comprised in each of the model sets o and a work order set produced by a production line assigned for the model, as shown in formulas (6) and (7). Specifically, MMSₚ represents the work order set corresponding to the model p, and MDSo represents the model sets corresponding to the model set o.

$${\sum }_{p ∈ {MDS}_{o}} {\sum }_{i ∈ {MMS}_{p} ⋂ {MLS}_{j}} {x}_{ij} \geq {φ}_{oj} , o = 1 , 2 , ... , O , j ∈ {LSS}_{o} \qquad ( 6 )$$

$${\sum }_{p ∈ {MDS}_{o}} {\sum }_{i ∈ {MMS}_{p} ⋂ {MLS}_{j}} {x}_{ij} \leq M \cdot {φ}_{oj} , o = 1 , 2 , ... , O , j ∈ {LSS}_{o} \qquad ( 7 )$$

Formulas (6) and (7) show that if the model set o is assigned to the production line j(φₒⱼ=1), then the upper and lower limits of the number of work orders corresponding to the production line j to which the model set o is assigned are 1≤Σ_{p∈MDS}_{ₒ}Σ_{i∈MMS}_{ₚ}_{∩MLS}_{ⱼ}≤M; otherwise, Σ_{p∈MDS}_{ₒ}Σ_{i∈MMS}_{ₚ}_{∩MLS}_{ⱼ}xᵢⱼ=0. In practice, there is a corresponding relationship between the model of the model set and the work order. By using this constraint formula, it is possible to realize the rationality of the assignment of the work order and the model set, and ensure that the schedule plan conforms to the planning logic.

The first limiting condition 1-4 is provided to limit the number of fixtures required for the production of each model set in corresponding assigned production line, as shown in formula (8). Specifically, UJNₒⱼ is the number of fixture sets required for the production of the model set o on the production line j, and JNₒ is the number of available fixture sets for the model set o.

$${\sum }_{j ∈ {LSS}_{o}} {UJN}_{oj} \cdot {φ}_{oj} \leq {JN}_{o} , o = 1 , 2 , ... , O \qquad ( 8 )$$

Formula (8) shows that the number of fixture sets (Σ_{j∈LSS}_{ₒ}UJNₒⱼ·φₒⱼ) required to produce the model set o must not exceed the number of available fixture sets JNₒ for the model set o. In practice, the number of fixture sets required for the production of model set in various production lines varies, and the actual number of fixtures available for use is also limited. By using this constraint formula, it is possible to ensure that the schedule plan meets the limitation of manufacturing resources.

The first limiting condition 1-5 is provided to limit that the total amount of work order production for each unit production line set must not exceed the upper limit of maximum allocation production quantity, as shown in formula (9). Specifically, MLSⱼ is the work order set that may be produced by the production line j, DMQᵢ is the demand for work order i, and MPQ is the upper limit of maximum allocation production quantity of unit production line.

$${\sum }_{j ∈ CLS} {\sum }_{i ∈ {MLS}_{j}} {DMQ}_{i} \cdot {x}_{ij} \leq MPQ \qquad ( 9 )$$

Formula (9) shows that the sum of the production quantity of each unit production line (Σ_{j∈CLS}Σ_{i∈MLS}_{ⱼ}DMQᵢ·xᵢⱼ) must not exceed the upper limit of maximum allocation production quantity MPQ. In practice, schedule plan needs to take into consideration the capacity utilization rate of the standard production line, and make the production of work orders to be concentrated on the standard production line as much as possible. By using this constraint formula, it is possible to realize the rationality of work order production allocation and ensure that the schedule plan conforms to the planning logic.

The first limiting condition 1-6 is provided to limit the maximum number of configurable standard production lines MLNₒ for each model set o as shown in formula (10).

$${\sum }_{j ∈ {LSS}_{o} \backslash CLS} {φ}_{oj} \leq {MLN}_{o} , o = 1 , 2 , ... , O \qquad ( 10 )$$

Formula (10) shows that the upper limit of the number of assigned standard production lines for each model set o is MLNₒ. In practice, schedule plan needs to take into consideration the concentration of the production allocation of the same model set to avoid over distribution and reduce the time of material preparation as well as the number of line switching. By using this constraint formula, it is possible to realize the rationality of assigning production line to model set and ensure that the schedule plan is able to meet the practical operation limitations.

The first limiting condition 1-7 is provided to limit the upper limit of the production time of the work orders included in each production line, as shown in formula (11). Specifically, TTᵢⱼ is the production cycle time of work order i on production line j, ACPⱼ is the available capacity of production line j in the planning period, and CRA is the production capacity relaxation ratio of each production line.

$${\sum }_{i ∈ {MLS}_{j}} {DMQ}_{i} \cdot {x}_{ij} \cdot {TT}_{ij} \leq {ACP}_{j} \cdot ( 1 + CRA ) , \qquad ( 11 )$$

$$j ∈ \{ 1 , 2 , ... , m \} \backslash CLS$$

Formula (11) shows production allocation quantity planned by each standard production line j∈{1, 2, . . . ,m} \CLS, and the upper limit of production time thereof is ACPⱼ·(1+CRA). In practice, the actual available capacity of each production line may be limited due to the planning of other activities. By using this constraint formula, it is possible to establish the feasibility of work order production allocation, while integrating the application of capacity relaxation ratio to improve the flexibility of schedule plan. The production line switching counts optimization model 215 is provided to:

based on the second objective function, in the case of satisfying a plurality of second limiting conditions, limit the production line switching counts of each production line. The second objective function is set to minimize total standard production line switch counts, as shown in formula (T2). Specifically, CHⱼ is the production line switch counts planned for the production line j, CHⱼ≥0 and CHⱼ is an integer, j=1, 2, . . . ,m.

$$Min {\sum }_{j ∈ \{ 1 , 2 , ... , m \} \backslash CLS} {CH}_{j} \qquad ( T2 )$$

Formula (T2) is to minimize total standard production line switch counts. By applying the second objective function, it is possible to help users quickly obtain the work order assignment plan with the optimal operating efficiency under the condition of satisfying the limitation of various manufacturing practices.

The second limiting condition 2-1 is provided to limit that the sum of the production allocation quantity of the work order satisfies the target production quantity, as shown in formula (12). LESᵢ is the production line set capable of producing work order i, DMQᵢ is the demand for work order i, and TPQ is the target production quantity corresponding to the optimal solution of the assignment model 213.

$${\sum }_{i = 1}^{n} {\sum }_{j ∈ {LES}_{i}} {DMQ}_{i} \cdot {x}_{ij} \geq TPQ \qquad ( 12 )$$

Formula (12) shows that the sum of the production allocation quantity of the work order needs to meet the target production quantity TPQ. By using this constraint formula, it is possible to ensure that the schedule plan is able to meet the total production quantity planned by the assignment model 213, so that the capacity utilization rate is able to reach the target level.

The second limiting condition 2-2 is provided to limit a production line switching count for each production line, as shown in formula (13). SLSⱼ is a set composed of the set numbers of the models corresponding to production line j.

$$\begin{matrix}{CH}_{j} = {\sum }_{o ∈ {SLS}_{j}} {φ}_{oj} - {u}_{j} , & j = 1 , 2 , … , m\end{matrix} \qquad ( 13 )$$

Formula (13) shows the calculation method of the number of production line switches for each production line. According to the second limiting condition 2-4 (Formula (16)˜ (18)), it may be deduced that if production line j is assigned with a model set (uⱼ=1), then the total number of model set that is assigned to be produced is, Σ_{o∈SLS}_{ⱼ}φₒⱼ≥1, therefore, production line switch counts is CHⱼ=Σ_{o∈SLS}_{ⱼ}φₒⱼ−1; otherwise, if uⱼ=0, then the total number of model set that is assigned to be produced is Σ_{o∈SLS}_{ⱼ}φₒⱼ=0 and the production line switch counts is CHⱼ=0. By using this constraint formula, it is possible to ensure the consistency between the calculation of the production line switch counts and actual operation.

The second limiting condition 2-3 is provided to satisfy the priority work order assignment plan planned by the assignment model 213, as shown in formulas (14) and (15). CMS is a priority weight work order assignment set corresponding to the optimal solution of the assignment model 213.

$$\begin{matrix}{\sum }_{j ∈ {LES}_{i}} {x}_{ij} \leq 1 , & i = 1 , 2 , … , n\end{matrix} \qquad ( 14 )$$

$$\begin{matrix}{\sum }_{j ∈ {LES}_{i}} {x}_{ij} = 1 , & i ∈ CMS\end{matrix} \qquad ( 15 )$$

Formula (15) shows that the schedule plan needs to meet the assignment constraint of the priority work order assignment set planned by the assignment model 213, so that the work order completion rate is able to meet the target level.

The second limiting condition 2-4 is shown in formulas (16) to (18), which is the same as the first limiting condition 1-2.

$$\begin{matrix}{\sum }_{o ∈ {SLS}_{j}} {φ}_{oj} \geq {u}_{j} , & j = 1 , 2 , … , m\end{matrix} \qquad ( 16 )$$

$$\begin{matrix}{\sum }_{o ∈ {SLS}_{j}} {φ}_{oj} \leq ( TCH + 1 ) \cdot {u}_{j} , & j ∈ \{ 1 , 2 , … , m \} \backslash CLS\end{matrix} \qquad ( 17 )$$

$$\begin{matrix}{\sum }_{o ∈ {SLS}_{j}} {φ}_{oj} \leq M \cdot {u}_{j} , & j ∈ CLS\end{matrix} \qquad ( 18 )$$

The second limiting condition 2-5 is shown in formulas (19) and (20), which are the same as the first limiting condition 1-3.

$$\begin{matrix}{\sum }_{p ∈ {MDS}_{o}} {\sum }_{i ∈ {MMS}_{p} ⋂ {MLS}_{j}} {x}_{ij} \geq {φ}_{oj} , & o = 1 , 2 , … , O , j ∈ {LSS}_{o}\end{matrix} \qquad ( 19 )$$

$$\begin{matrix}{\sum }_{p ∈ {MDS}_{o}} {\sum }_{i ∈ {MMS}_{p} ⋂ {MLS}_{j}} {x}_{ij} \leq M \cdot {φ}_{oj} , & o = 1 , 2 , … , O , j ∈ {LSS}_{o}\end{matrix} \qquad ( 20 )$$

The second limiting condition 2-6 is shown in formula (21), which is the same as the first limiting condition 1-4.

$$\begin{matrix}{\sum }_{j ∈ {LSS}_{o}} {UJN}_{oj} \cdot {φ}_{oj} \leq {JN}_{o} , & o = 1 , 2 , … , O\end{matrix} \qquad ( 21 )$$

The second limiting condition 2-7 is shown in formula (22), which is the same as the first limiting condition 1-5.

$${\sum }_{j ∈ CLS} {\sum }_{i ∈ {MLS}_{j}} {DMQ}_{i} \cdot {x}_{ij} \leq MPQ \qquad ( 22 )$$

The second limiting condition 2-8 is shown in formula (23), which is the same as the first limiting condition 1-6.

$$\begin{matrix}{\sum }_{j ∈ {LSS}_{o} \backslash CLS} {φ}_{oj} \leq {MLN}_{o} , & o = 1 , 2 , … , O\end{matrix} \qquad ( 23 )$$

The second limiting condition 2-9 is shown in formula (24), which is the same as the first limiting condition 1-7.

$${\sum }_{i ∈ {MLS}_{j}} {DMQ}_{i} \cdot {x}_{ij} \cdot {TT}_{ij} \leq {ACP}_{j} \cdot ( 1 + CRA ) , \qquad ( 24 )$$

$$j ∈ \{ 1 , 2 , … , m \} \backslash CLS$$

The priority weight evaluation model 211 is designed based on the assignment model 213, and its function is mainly to determine whether there is a feasible solution with the given data (such as work order related data, production line data, fixture sets demand data, model set data, weight etc.), and feedback the solution information for users to evaluate and adjust relevant parameters. In the practical planning process, it is necessary to prioritize the assignment of work orders with higher weights to the appropriate production line to meet specific scheduling performance indicators. However, the setting of priority weights is mainly limited by manufacturing resources such as available capacity and the number of fixture sets, which often results in only part of work orders corresponding to priority weights being able to be assigned.

The design concept of the priority weight evaluation model 211 is to maximize the total number of priority weights that can be assigned to complete work orders as the goal, and to confirm whether there is a feasible solution for the given data has under the setting of the current priority work order weight set. If the optimal target value of the model solution is equal to the total number of preset priority weights, it means that the given data has a feasible solution in the currently set priority work order weight set, and the assignment model 213 and the production line switching counts optimization model 215 may be further used in sequence for solution; otherwise, the priority weight evaluation model 211 automatically adjusts the priority work order weight set that can complete work order assignment, and then executes the assignment model 213 and the production line switching counts optimization model 215 for solution.

Compared with the mathematical model constructed by the conventional schedule planning system, it is very likely that the parameter value setting cannot meet the requirements related to priority weight work order assignment, and consequently it takes a long time for the model to be solved and unable to give feedback in time to provide the user with suggestion in adjustment of the parameter value. As a result, the user can only spend a lot of time adjusting the parameter combination and repeatedly performing model solving by trial and error. The priority weight evaluation model 211 designed in this embodiment is not only able to effectively improve the solution efficiency of the overall planning system, but also has an intelligent automatic parameter adjustment function for users' reference to determine the optimal work order assignment plan.

The priority weight evaluation model 211 first determines whether each work order in the priority work order weight set can be assigned to the corresponding production line based on the third objective function and under the condition of satisfying a plurality of third limiting conditions. In response to each work order in the priority work order weight set being assigned to a corresponding production line, the assignment model 213 is executed. In response to at least one work order in the priority work order weight set being unable to be assigned to the corresponding production line, displaying feedback information on the user interface.

The third objective function is to maximize the total number of priority weights, as shown in formula (T3). Specifically, CWS is the priority work order weight set, w represents the weight, and w∈CWS. α_{w} indicates whether all the work orders corresponding to the weight w are assigned, if so, then α_{w}=1; otherwise, α_{w}=0. α_{w}∈{0, 1}, and α_{w} is an integer.

$$\begin{matrix}Max & {\sum }_{w ∈ CWS} {α}_{w}\end{matrix} \qquad ( T3 )$$

The third limiting condition 3-1 is set to limit that each work order whose priority weight conforms to the priority work order weight set is assigned to a production line, as shown in formulas (25) and (26).

$$\begin{matrix}{\sum }_{j = 1}^{m} {\sum }_{i ∈ {WMS}_{w} ⋂ {MLS}_{i}} {x}_{ij} \geq \vert {WMS}_{w} \vert \cdot {α}_{w} , & w ∈ CWS\end{matrix} \qquad ( 25 )$$

$${\sum }_{j = 1}^{m} {\sum }_{i ∈ {WMS}_{{w}^{′}} ⋂ {MLS}_{j}} {x}_{ij} \leq M \cdot {α}_{w ,} w ∈ CWS , {w}^{′} ∈ WES < w \qquad ( 26 )$$

Formula (25) shows that if α_{w}=1, it means that all work orders corresponding to the priority weight W∈CWS need to be assigned, that is, Σⱼ₌₁^{m}Σ_{i∈WMS}_{_{w}}_{∩MLS}_{ⱼ}xᵢⱼ≥|WMS_{w}|. WES is a work order weight set. Formula (26) shows that if the work order corresponding to the priority weight w∈CWS has not been assigned (α_{w}=0), then the work order corresponding to the lower weight w′ (w′<w) in the work order weight set WES cannot be assigned, i.e., Σⱼ₌₁^{m}Σ_{i∈WMS}_{_{w′}}_{∩MLS}_{ⱼ}xᵢⱼ=0. In practice, schedule plan needs to take into consideration prioritizing the completion of work orders with priority weights to meet specific performance indicators. By using this constraint formula, it is possible to realize the rationality of resource allocation and ensure that the schedule plan conforms to the planning logic.

The third limiting condition 3-2 is set to limit each work order to be assigned to one production line at most, as shown in formula (27), which is the same as the formula (1) in the first limiting condition 1-1.

$$\begin{matrix}{\sum }_{j ∈ {LES}_{i}} {x}_{ij} \leq 1 , & i = 1 , 2 , … , n\end{matrix} \qquad ( 27 )$$

The third limiting condition 3-2 is shown in formulas (28) to (30), which is the same as the first limiting condition 1-2.

$$\begin{matrix}{\sum }_{o ∈ {SLS}_{j}} {φ}_{oj} \geq {u}_{j} , & j = 1 , 2 , … , m\end{matrix} \qquad ( 28 )$$

$$\begin{matrix}{\sum }_{o ∈ {SLS}_{j}} {φ}_{oj} \leq ( TCH + 1 ) \cdot {u}_{j} , & j ∈ \{ 1 , 2 , … , m \} \backslash CLS\end{matrix} \qquad ( 29 )$$

$$\begin{matrix}{\sum }_{o ∈ {SLS}_{j}} {φ}_{oj} \leq M \cdot {u}_{j} , & j ∈ CLS\end{matrix} \qquad ( 30 )$$

The third limiting condition 3-3 is shown in formulas (31) and (32), which is the same as the first limiting condition 1-3.

$$\begin{matrix}{\sum }_{p ∈ {MDS}_{o}} {\sum }_{i ∈ {MMS}_{p} ⋂ {MLS}_{j}} {x}_{ij} \geq {φ}_{oj} , & o = 1 , 2 , … , O , j ∈ {LSS}_{o}\end{matrix} \qquad ( 31 )$$

$${\sum }_{p ∈ {MDS}_{o}} {\sum }_{i ∈ {MMS}_{p} ⋂ {MLS}_{j}} {x}_{ij} \leq M \cdot {φ}_{oj} , o = 1 , 2 , … , O , j ∈ {LSS}_{o} \qquad ( 32 )$$

The third limiting condition 3-4 is shown in formula (33), which is the same as the first limiting condition 1-4.

$$\begin{matrix}{\sum }_{j ∈ {LSS}_{o}} {UJN}_{oj} \cdot {φ}_{oj} \leq {JN}_{o} , & o = 1 , 2 , … , O\end{matrix} \qquad ( 33 )$$

The third limiting condition 3-5 is shown in formula (34), which is the same as the first limiting condition 1-5.

$${\sum }_{j ∈ CLS} {\sum }_{i ∈ {MLS}_{j}} {DMQ}_{i} \cdot {x}_{ij} \leq MPQ \qquad ( 34 )$$

The third limiting condition 3-6 is shown in formula (35), which is the same as the first limiting condition 1-6.

$${\sum }_{j ∈ {LSS}_{o} \backslash CLS} {φ}_{oj} \leq {MLN}_{o} , \qquad ( 35 )$$

$$o = 1 , 2 , … , O$$

The third limiting condition 3-7 is shown in formula (36), which is the same as the first limiting condition 1-7.

$${\sum }_{i ∈ {MLS}_{j}} {DMQ}_{i} \cdot {x}_{i j} \cdot {TT}_{i j} \leq {ACP}_{j} \cdot ( 1 + CRA ) , \qquad ( 36 )$$

$$j ∈ \{ 1 , 2 , … , m \} ∖ CLS$$

The work order form batching module 122 takes into consideration the production line material preparation mode and batch limit based on work order attributes (for example, model, main substitute material, material station relationship, operation method, etc.) to construct a binary integer programming model to solve form batching strategy for work orders corresponding to various production lines.

Based on the fourth objective function, and in the case of satisfying a plurality of fourth limiting conditions, the work order form batching module 122 performs form batching for the plurality of work orders among the work orders included in the multiple batches with the same attribute into a work order group based an attribute of each of the work orders.

The fourth objective function is to minimize the total number of batches under the goal of maximizing the number of form batched total weighted work orders, as shown in formula (37). Specifically, 1 represents a work order group, that is, a group composed of work orders with the same attributes that can be considered to be assembled into the same batch. xᵢⱼₖ indicates whether work order i of production line j is assigned to batch k, if so, xᵢⱼₖ=1; otherwise, xᵢⱼₖ=0. xᵢⱼₖ∈{0, 1}, j=1, 2, . . . ,m, i∈MLSⱼ, k=1, 2, . . . , GPNⱼ. GPNⱼ is the upper limit of the number of batches corresponding to production line j. φⱼₖₗ indicates whether batch k of production line j belongs to work order group 1, if so, φⱼₖₗ=1; otherwise, φⱼₖₗ=0. φⱼₖₗ∈{0, 1}, j=1, 2, . . . ,m, k=1, 2, . . . , GPNⱼ, l∈GLSⱼ. GLSⱼ is the set of work order group numbers corresponding to production line j. MLSⱼ is the work order set assigned to production line j.

$$Max M \cdot {\sum }_{j = 1}^{m} {\sum }_{k = 1}^{{GPN}_{j}} {\sum }_{i ∈ {MLS}_{j}} {WTD}_{i} \cdot {x}_{ijk} - {\sum }_{j = 1}^{m} {\sum }_{k = 1}^{{GPN}_{j}} {\sum }_{l ∈ {GLS}_{j}} {φ}_{jkl} \qquad ( 37 )$$

Formula (37) is to further minimize the total number of batches (minimize the total number of batches by subtracting Σⱼ₌₁^{m}Σₖ₌₁^{GPN}^{ⱼ}Σ_{l∈GLS}_{ⱼ}φⱼₖₗ) under the primary goal of maximizing the number of form batched total weighted work orders. By using this objective function, it is possible to help users to quickly obtain the work order form batching plan with the optimal batch utilization rate under the constraints of various manufacturing practices.

The fourth limiting condition 4-1 is set to limit each work order in each production line to be assigned to one batch at most, and the number of batches included in each production line will not exceed the upper limit of the number of batches, as shown in formula (38). Formula (38) shows that each work order of each production line can be assigned to a certain batch at most. MLSⱼ is the work order set assigned to production line j.

$${\sum }_{k = 1}^{{GPN}_{j}} {x}_{ijk} \leq 1 , \qquad ( 38 )$$

$$j = 1 , 2 , … , m ,$$

$$i ∈ {MLS}_{j}$$

The fourth limiting condition 4-2 is set to limit each batch in each production line to belong to one work order group at most, as shown in formula (39). Formula (39) shows that each batch of each production line belongs to a certain work order group at most.

$${\sum }_{l ∈ {GLS}_{j}} {φ}_{jkl} \leq 1 , \qquad ( 39 )$$

$$j = 1 , 2 , … , m ,$$

$$k = 1 , 2 , … , {GPN}_{j}$$

The fourth limiting condition 4-3 is set to determine whether the batches in each production line belong to any work order group, so as to generate the next batch when it is determined that the current batch belongs to any work order group, otherwise the next batch is not generated, as shown in formula (40).

$${\sum }_{l ∈ {GLS}_{j}} {φ}_{jkl} \geq {\sum }_{l ∈ {GLS}_{j}} {φ}_{jk + 1 l} , \qquad ( 40 )$$

$$j = 1 , 2 , … , m ,$$

$$k = 1 , 2 , … , {GPN}_{j} - 1$$

Formula (40) shows that only if the batch k of production line j belongs to a certain work order group, that is, Σ_{l∈GLS}_{ⱼ}φⱼₖₗ=1, then the production line generates batches k+1 (Σ_{l∈GLS}_{ⱼ}φⱼₖ₊₁ₗ=1 or 0); otherwise, it is not considered to generate the batch k+1 (Σ_{l∈GLS}_{ⱼ}φⱼₖ₊₁ₗ=0). In practice, the batch numbers of work order form batching must be continuously incremented to facilitate the management of scheduling information and material preparation and dispatching operations. By using this constraint formula, it is possible ensure the correctness of batch number that is generated.

The fourth limiting condition 4-4 is set for each work order group included in the work order group number set corresponding to each production line to limit the upper and lower limits of the number of work orders in the work order set corresponding to each work order group as shown in formulas (41) and (42). MGSₗ is the work order set corresponding to work order group 1.

$${\sum }_{i ∈ {MGS}_{l}} {x}_{ijk} \leq {φ}_{jkl} \cdot \vert {MGS}_{l} \vert , \qquad ( 41 )$$

$$j = 1 , 2 , … , m ,$$

$$k = 1 , 2 , … , {GPN}_{j} ,$$

$$l ∈ {GLS}_{j}$$

$${\sum }_{i ∈ {MGS}_{l}} {x}_{ijk} \geq {φ}_{jkl} , \qquad ( 42 )$$

$$j = 1 , 2 , … , m ,$$

$$k = 1 , 2 , … , {GPN}_{j} ,$$

$$l ∈ {GLS}_{j}$$

Formulas (41) and (42) show that if the batch k of the production line j belongs to the work order group 1 (φⱼₖₗ=1), then the upper and lower limits of the number of work orders assigned to the production line batch group 1 is 1≤Σ_{i∈MGS}_{ₗ}xᵢⱼₖ≤|MGSₗ|; otherwise, work orders belonging to group 1 cannot be assigned to production line batches (Σ_{i∈MGS}_{ₗ}xᵢⱼₖ=0). In practice, there is a corresponding relationship between work order groups and work orders, and this constraint formula is set to ensure that the batch assignment of work orders conforms to the planning logic.

The fourth limiting condition 4-5 is set to limit that the total demand quantity of the work order demand meets the upper and lower limits of the batch quantity, as shown in formulas (43) and (44). DMQᵢ is the demand of work order i. LTUₗ and LTLₗ respectively indicate the upper limit and lower limit of the batch quantity of the work order group 1.

$${\sum }_{i ∈ {MGS}_{l}} {DMQ}_{i} \cdot {x}_{ijk} \geq {φ}_{jkl} \cdot {LTL}_{l} , \qquad ( 43 )$$

$$j = 1 , 2 , … , m ,$$

$$k = 1 , 2 , … , {GPN}_{j} ,$$

$$l ∈ {GLS}_{j}$$

$${\sum }_{i ∈ {MGS}_{l}} {DMQ}_{i} \cdot {x}_{ijk} \leq {φ}_{jkl} \cdot {LTU}_{l} , \qquad ( 44 )$$

$$j = 1 , 2 , … , m ,$$

$$k = 1 , 2 , … , {GPN}_{j} ,$$

$$l ∈ {GLS}_{j}$$

Formulas (43) and (44) show that if the batch k of the production line j belongs to the work order group 1 (φⱼₖₗ=1), the total number of work order demand quantity assigned to the production line batch must satisfy the upper and lower limits of the batch quantity corresponding to the group (LTLₗ≤Σ_{i∈MGS}_{ₗ}DMWᵢ·xᵢⱼₖ≤LTUₗ); otherwise, it can be deduced that Σ_{i∈MGS}_{ₗ}DMQᵢ·xᵢⱼₖ=0. In practice, different work order groups correspond to different upper and lower limits of batch quantity. By using this constraint formula, it is possible to ensure that work order batches conform to the planning logic.

In an embodiment, the work order detailed scheduling module 123 is established based on ant colony optimization (ACO). The ACO algorithm is an artificial intelligence heuristic algorithm developed by simulating the behavior of ants searching for the shortest path in the process of foraging in nature. When ants are foraging, they leave a certain amount of pheromones on the path they visit as a communication medium, and then when the ants choose a path, they refer to the amount of pheromones to choose the path. In the process of ants randomly choosing paths, the ants that choose a shorter path can go back and forth between the nest and the food in a short time, so relatively speaking, the accumulation of pheromones of ants on this path are more, so the ants are more likely to choose the shorter path; with this feedback mechanism, almost all ants will choose the shorter path in the end.

ACO imitates the behavior pattern of ant groups in the real world, and adopts multiple iterative calculations to allow artificial ants to search for the optimal solution. This common algorithm has been widely applied in combinatorial optimization problems. The main search characteristics of ACO are as follows.

(1) Positive feedback: This process is a step of self-enhancement of the algorithm, so that the path chosen by more artificial ants attract more ants to achieve the self-learning ability of the algorithm, so as to facilitate the algorithm to quickly obtain an approximate optimal solution. (2) Distributed computing: The characteristics of parallel search by multiple artificial ants make it possible to avoid premature convergence to the local optimum. (3) Greedy heuristic rule: The biggest difference between artificial ants and real ants is that artificial ants are not completely blind, and are able to determine the direction of travel by using heuristic information in addition to pheromones.

The work order detailed scheduling module 123 is a two-stage solution plan. In the calculation step of the first stage, the same SOP model set assigned for each production line is sorted, and the corresponding scheduled start time and scheduled completion time are calculated. Then, in the calculation step of the second stage, the ACO algorithm is adopted to achieve the goal of maximizing the total weighted work order completion rate, and the detailed schedule plan for work order batches and individual work orders in the model set with the same SOP is carried out.

In the calculation step of the first stage, first, for the production lines j=1, 2, . . . ,m, the first category set is set as COFⱼ={o|CHOⱼₒ=1, o∈SASⱼ} and the second category set is set as CONⱼ={o|CHOⱼₒ=0, o∈SASⱼ}. The model set assigned in the production line in the first category set COFⱼ does not need to be switched to another production line, the model set assigned in the production line in the second category set CONⱼ needs to be switched to another production line. SASⱼ is a set composed of the set numbers of models with the SOP in production line j. CHOⱼₒ indicates whether the model set o sequentially assigned to the production line j does not need to be switched to another production line, if there is no need to switch to another production line, then CHOⱼₒ=1; otherwise, CHOⱼₒ=0.

Then, for the production line j=1, 2, . . . ,m, the model sets o included in each of the first category set COFⱼ and the second category set CONⱼ are sorted in a non-increasing sequence based on their own representative weight MWTⱼₒ, and MWTⱼₒ is the representative weight of the model set o of the production line j. For example, MWTⱼₒ=max_{K∈NBS}_{ⱼₒ}{BWTⱼₒₖ}. NBSⱼₒ is the batch set of model set o of production line j. BWTⱼₒₖ is the representative weight of batch k in the model set o of production line j. BWTⱼₒₖ=max_{i∈BAS}_{ⱼₒₖ}{WTDᵢ}. BASⱼₒₖ is the work order set of the batch k of the model set o of production line j, and WTDᵢ represents the weight of work order i. Then, the production time MPTⱼₒ of each model set o of the production line j is calculated. For example, MPTⱼₒ=Σ_{k∈NBS}_{ⱼₒ}BPTⱼₒₖ. NBSⱼₒ is the batch set of model set o of the production line j. BPTⱼₒₖ is the production time of batch k of the model set o in production line j. BPTⱼₒₖ=Σ_{i∈BAS}_{ⱼₒₖ}TTᵢⱼ·DMQᵢ. BASⱼₒₖ is the work order set of batch k of the model set o in production line j, TTᵢⱼ is the production cycle time of work order i on the production line j, and DMQᵢ is the demand for work order i.

Afterwards, for the first category set COFⱼ, based on the sorted results of each model set, the scheduled start time SSTₒ and scheduled completion time SCTₒ of each model set o included in the first category set COFⱼ are calculated based on the operable time of each of these production lines and the production time MPTⱼₒ of each model set o in sequence. That is, for production line j=1, 2, . . . ,m, the following formulas (45)˜ (47) are repeatedly and sequentially adopted to calculate the scheduled start time SSTₒ and scheduled completion time SCTₒ of the model set o in each sorted position in the first category set COFⱼ in sequence.

$${SST}_{o} = {LST}_{j} \qquad ( 45 )$$

$${SCT}_{o} = {SST}_{o} + {MPT}_{jo} \qquad ( 46 )$$

$${LST}_{j} = {SCT}_{o} \qquad ( 47 )$$

Formula (45) shows that the scheduled start time SSTₒ of the model set o is equal to the current operable time LSTⱼ of production line j. Formula (46) shows that the scheduled completion time SCTₒ of the model set o is equal to the scheduled start time SSTₒ plus the corresponding production time MPTⱼₒ. Formula (47) shows that the current operable time LSTⱼ of production line j is updated to SCTₒ, and the initial model set number INSⱼ of production line j is updated to o.

Moreover, for the second category set CONⱼ, based on the sorted results of each model set, the scheduled start time SSTₒ and scheduled completion time SCTₒ of each model set included in the second category set CONⱼ are calculated based on the operable time LSTⱼ of each production line, the production line switching time COT_{o′o} of switching one model set to another model set and the production time MPTⱼₒ of each model set in sequence. That is, for production line j=1, 2, . . . ,m, the following formulas (48)˜ (50) are repeatedly and sequentially adopted to calculate the scheduled start time SSTₒ and scheduled completion time SCTₒ of the model set o in each sorted position in the second category set CONⱼ in sequence.

$${SST}_{o} = {LST}_{j} + {COT}_{{o}^{′} o} \qquad ( 48 )$$

$${SCT}_{o} = {SST}_{o} + {MPT}_{jo} \qquad ( 49 )$$

$${LST}_{j} = {SCT}_{o} \qquad ( 50 )$$

It is set that o′=INSⱼ, formula (48) shows that the scheduled start time SSTₒ of the model set o is equal to the current operable time LSTⱼ of the production line j plus the corresponding production line switching time COT_{o′o}. Formula (49) shows that the scheduled completion time SCTₒ of the model set o is equal to the scheduled start time SSTₒ plus the corresponding production time MPTⱼₒ. Formula (50) shows that the current operable time LSTⱼ of production line j is updated to SCTₒ, and the initial model set number INSⱼ of production line j is updated to o.

The calculation step in the second stage includes three parts: a solution construction step, a pheromone update step, and a self-adaptive calculation step.

Solution construction step: A combination (j, o, k, l) is determined to perform solution construction for each iteration. The combination (j, o, k, l) indicates the l-th sorted position in which the batch k is sorted in the model set o of production line j, k∈NBSⱼₒ, j=1, 2, . . . , m, o∈SASⱼ, 1=1,2, . . . |NBSⱼₒ|, NBSⱼₒ is the batch set of model set o of production line j, m is the total number of production lines, SASⱼ is a set composed of model set numbers with the same SOP in production line j.

Specifically speaking, solution construction further plans the detailed scheduling of each work order batch and individual work order within the model set already assigned for each production line. The basic design concept of the ACO algorithm is to use the pheromone value (j,o,k,l) to represent that the selected batch k is sorted at the l-th position in the model set o of the production line j, and the degree of preference corresponding to this solution construction. In the meantime, the heuristic value (j,o,k) corresponding to the batch k in the model set o of the production line j is taken into consideration. The following formula (51) shows that the heuristic value is the ratio of the representative weight BWTⱼₒₖ to the production time BPTⱼₒₖ of the batch k in the model set o of production line j.

$$η ( j , o , k ) = {BWT}_{jok} / {BPT}_{jok} \qquad ( 51 )$$

In the solution construction process for each iteration, each ant comprehensively evaluates the pheromone value and the heuristic value to determine the sorted position of each batch in the model set on each production line according to the pseudo-random-proportional rule. Further, the scheduled start time and scheduled completion time of each work order in each batch are calculated, and the above process is repeated until scheduling of all batches of work order has been completed.

In the pseudo-random-proportional rule, the ants select the batches k∈NBSⱼₒ to be sorted on production line j=1, 2, . . . , m, and the probability calculation method of the 1-th (l=1,2, . . . ,|NBSⱼₒ|) sorted position in the model set o∈SASⱼ is shown in formulas (52) and (53).

$$( k , l ) = arg {max}_{k ∈ {NBS}_{jo} , l = 1 , 2 , … , \vert {NBS}_{jo} \vert} \{ {[ τ ( j , o , k , l ) ]}^{α} \cdot {[ η ( j , o , k ) ]}^{β} \} \qquad ( 52 )$$

$$( 53 )$$

$${P}_{r} ( k , l ) = \{ \begin{matrix} & \frac{{[ τ ( j , o , k , l ) ]}^{α} \cdot {[ η ( j , o , k ) ]}^{β}}{{\sum }_{{k}^{′} ∈ {NBS}_{jo} , {l}^{′} = 1 , 2 , … , \vert {NBS}_{jo} \vert} {[ τ ( j , o , {k}^{′} , {l}^{′} ) ]}^{α} \cdot {[ η ( j , o , {k}^{′} ) ]}^{β}} \\ & if k ∈ {NBS}_{jo} , l = 1 , 2 , … , \vert {NBS}_{jo} \vert , \\ 0 & otherwise .\end{matrix}$$

In formula (53), the definitions of k′ and l′ used in the denominator are the same as the definitions of k and l in the above-mentioned description, and the symbols k′ and l′ are only used to distinguish the difference between the denominator of Pr(k,l) and the corresponding combination (k,l) of the numerator.

The search behavior of ants may be divided into depth “exploitation” and breadth “exploration”. The default parameter q₀ determines the degree of tendency of ants between the two, 0≤q₀≤1. The parameters α and β represent the corresponding weights of the pheromone value (j,o,k,l) and the heuristic value η(j,o,k) respectively. Formula (52) shows that if the random variable q≤q₀ conforms to the uniform distribution U[0,1], then the ants directly select the combination (k,l) corresponding to the maximum value of [τ(j,o,k,l)^{α}·[η(j,o,k)]^{β}. This search behavior is more like depth “exploitation”; otherwise, when q>q₀, the selection probability corresponding to each combination (k,l) is calculated according to formula (53). If the value of [τ(j,o,k,l)^{α}·[η(j,o,k)]^{β} is large, the probability of the corresponding combination (k,l) being selected is higher. Since ants make selection in a probabilistic manner, the one with the highest probability might not be selected. Therefore, ants may try to search for other solution spaces to avoid falling into local optimum, so such behavior is more like to breadth “exploration”.

After the batch k is determined to be sorted in the l-th sorted position in the model set o of the production line j by pseudo-random-proportional rule, the work order schedule plan for batch k includes the following steps a1 to a6.

In Step a1, the scheduled start time and scheduled completion time of batch k in model set o of production line j are calculated, as shown in formulas (54) and (55).

$${BST}_{jok} = \{ \begin{matrix}{SST}_{o} & \begin{matrix}If batch k is sorted in the first position in \\ model set o of production line j\end{matrix} \\ {BCT}_{jok} , & otherwise\end{matrix} \qquad ( 54 )$$

$${BCT}_{jok} = {BST}_{jok} + {BPT}_{jok} \qquad ( 55 )$$

Formula (54) shows that if the batch k is sorted in the first position of the model set o of production line j, its scheduling start time BSTⱼₒₖ is equal to the scheduled start time SSTₒ of the model set o; otherwise, the scheduled start time is equal to the scheduled completion time BCT_{jok′} of the batch k′ in the previous sorted position. Formula (55) shows that the scheduled completion time BCT jok of the batch k is equal to the scheduled start time BSTⱼₒₖ plus the corresponding production time BPTⱼₒₖ.

In step a2, each work order in batch k is sorted in non-increasing order according to the corresponding weight WTDᵢ (the weight of work order i).

In step a3, the scheduled start time MSTᵢⱼₒₖ and the scheduled completion time MCTᵢⱼₒₖ of the work order i at each sorted position in the batch k of the model set o of production line j are calculated in sequence and repeatedly through formulas (56) and (57). Specifically, i∈BASⱼₒₖ, BASⱼₒₖ is the work order set of the batch k of the model set o on the production line j. TTᵢⱼ is the production cycle time of work order i on production line j. DMQᵢ is the demand for work order i.

$${MST}_{ijok} = \{ \begin{matrix}{BST}_{jok} & \begin{matrix}If the work order i is sorted in the first position \\ of batch k in model set o of prodcution line j\end{matrix} \\ {MCT}_{i , jok} & otherwise\end{matrix} \qquad ( 56 )$$

$${MCT}_{ijok} = {MST}_{ijok} + {DMQ}_{i} \cdot {TT}_{ij} \qquad ( 57 )$$

Formula (56) shows that if work order i is sorted in the first sorted position in batch k of the model set o on the production line j, its scheduled start time MSTᵢⱼₒₖ is equal to the scheduled start time BSTⱼₒₖ of the batch k; otherwise, the scheduled start time is equal to the scheduled completion time MCT_{i′jok} of the work order i′ at the previous sorted position. Formula (57) shows that the scheduled completion time MCTᵢⱼₒₖ of work order i is equal to the scheduled start time MSTᵢⱼₒₖ plus the corresponding production time DMQᵢ·TTᵢⱼ.

When scheduling of all batches of work order have been planned, it means that the ant has completed the solution construction, and then continue to execute steps a4-a6. In step a4, the work order set HTS that reaches the target production process time is set as HTS, as shown in formula (58). Specifically, PTS represents the work order set whose goal is to meet the production process time, TPT represents the target production process time of the work order, and RLTᵢ is the release time of work order i.

$$HTS = \{ i \vert i ∈ PTS , {MCT}_{ijok} - RL {T}_{i} \leq TPT \} \qquad ( 58 )$$

In step a5, the work order set completed before the target due date is defined as HDS, as shown in formula (59). DDS represents the work order set whose goal is to meet the due date, and TDDᵢ is the target due date of work order i.

$$H D S = \{ i \vert i ∈ DDS , M C {T}_{ijok} \leq {TDD}_{i} \} \qquad ( 59 )$$

In step a6, the total weighted work order completion rate TWH is calculated, as shown in formula (60). WPT is the corresponding weight of the work order set that reaches the target production process time, and WDD is the corresponding weight of the work order set completed before the target due date.

$$TWH = WPT \cdot \frac{{\sum }_{i ϵ HTS} {DMQ}_{i}}{{\sum }_{i ϵ PTS} {DMQ}_{i}} + WDD \cdot \frac{{\sum }_{i ϵ HDS} {DMQ}_{i}}{{\sum }_{i ϵ DDS} {DMQ}_{i}} . \qquad ( 60 )$$

The pheromone update step may be divided into two types: “local pheromone update” and “global pheromone update”. This mechanism is mainly to update the pheromone value τ(j,o,k,l) of each combination (j,o,k,l), that is, the pheromone value corresponding to the batch k∈NBSⱼₒ sorted in the l-th position of the model set o∈SASⱼ in the production line j. The update mechanism and design concepts are described below.

Local pheromone update: When the ant adds the combination (j, o, k, l) into the currently constructed partial scheduling solution according to the pseudo-random-proportional rule, the formula (61) is set to update the pheromone value τ(j,o,k,l) corresponding to this combination. Specifically, the parameters θ (0<θ<1) and τ0 represent the pheromone volatilization rate and the initial value of pheromone respectively.

$$τ ( j , o , k , l ) ← ( 1 - θ ) \cdot τ ( j , o , k , l ) + θ \cdot {τ}_{0} \qquad ( 61 )$$

The main function of formula (61) is to make the pheromone values corresponding to each combination (j, o, k, l) volatilize at a certain rate and speed, so as to avoid the continuous accumulation of pheromone values corresponding to some combinations and prevent all ants from choosing the same combination, resulting in stagnation and early convergence to the local optimum.

Global pheromone update: When the ants complete the solution construction of the scheduling solution, global pheromone update is updated for all combinations (j, o, k, l) according to the determining conditions to strengthen depth “exploitation” of search behavior. Formulas (62) to (64) illustrate the calculation method for updating global pheromones. Specifically, s^{ib} and s^{bs} represent the current iteration solution and the current optimal solution, respectively, and w^{ib} and w^{bs} represent the corresponding weights of s^{ib} and s^{bs} respectively (w^{ib}+w^{bs}=1); the parameter ρ (0<ρ≤1) represents the pheromone volatilization rate.

$${C}^{ib} ( j , o , k , l ) = \{ \begin{matrix}1 & if ( j , o , k , l ) ∈ {s}^{i b} \\ 0 & otherwise .\end{matrix} , \qquad ( 62 )$$

$${C}^{bs} ( j , o , k , l ) = \{ \begin{matrix}1 & if ( j , o , k , l ) ∈ {s}^{bs} \\ 0 & otherwise .\end{matrix} ,$$

$$τ ( j , o , k , l ) ← τ ( j , o , k , l ) + ρ \cdot ( {w}^{i b} \cdot {C}^{ib} ( j , o , k , l ) \qquad ( 63 )$$

$$+ {w}^{b s} \cdot {C}^{b s} ( j , o , k , l ) - τ ( j , o , k , l ) ) \qquad ( 64 )$$

This design also takes into consideration the relative importance of the current iterative solution s^{ib} and the current optimal solution s^{bs}, and determines whether each combination (j,o,k,l) is established in s^{ib} and s^{bs}, and updates the corresponding pheromone value τ(j,o,k,l) accordingly. If the combination (j,o,k,l) belongs to both the current iterative solution s^{ib} and the current optimal solution s^{bs}, its corresponding pheromone value will increase as derived from formula (64), prompting ants to tend to choose this combination subsequently when constructing a scheduling solution.

The conventional ACO algorithm normally sets the default parameter q₀ as a fixed value. However, if the default parameter q₀ is set low, the search behavior of ants will tend to be breadth “exploration” with randomness; on the contrary, the tendency to depth “exploitation” will easily converge to the local optimum. Therefore, how to set an appropriate preset parameter q₀ to ensure that the algorithm is able to obtain an approximate optimal solution within a reasonable time is an important issue. The “adaptive algorithm step” proposed below is able to dynamically adjust the default parameter q₀ and initialize the pheromone value in the execution process according to the solution result of each iteration, so that the search strategy of ants may reach a balance between the breadth “exploration” and depth “exploitation”.

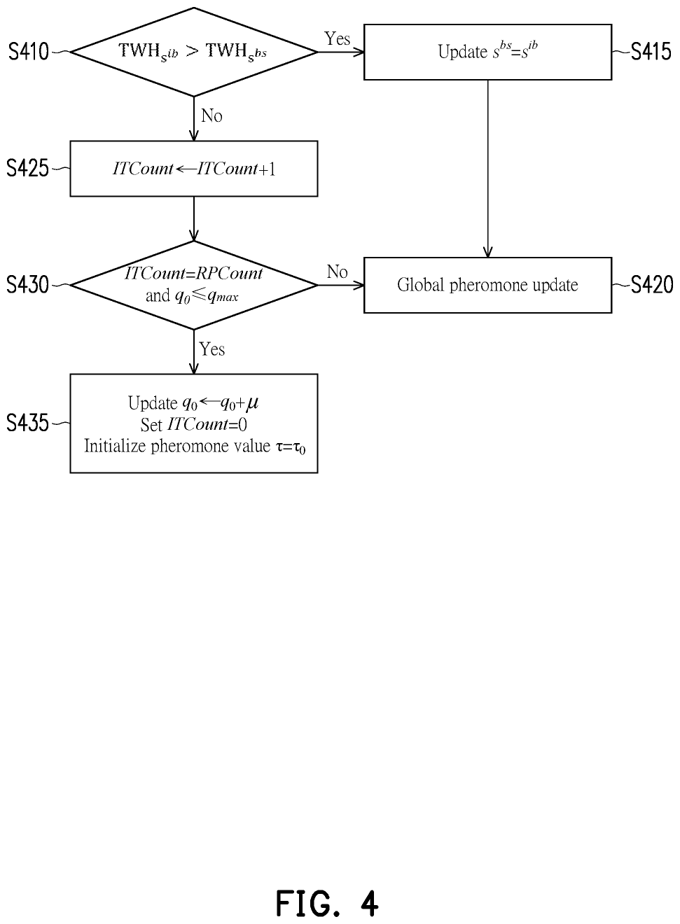

FIG. 4 is a flowchart of an adaptive algorithm according to an embodiment of the present disclosure. Please refer to FIG. 4, TWHₛ_{^{ib}} represents the total weighted work order completion rate corresponding to the current iterative solution s^{ib}, TWHₛ_{^{bs}} represents the total weighted work order completion rate corresponding to the current optimal solution s^{bs}, ITCount represents the accumulated iteration number of the current optimal solution s^{bs} that has not been updated, RPCount represents the threshold value of ITCount, and qₘₐₓ represents the upper limit value of q₀. During the construction of the scheduling solution for each iteration, it is determined whether the current iteration solution is better than the current optimal solution. In an embodiment, the scheduling solution obtained in the first iteration may be used as the initial current optimal solution, and then the current optimal solution is updated when a better scheduling solution is obtained.

In step S410, it is determined whether TWHₛ_{^{ib}} is greater than TWHₛ_{^{bs}}. If TWHₛ_{^{ib}} is greater than TWHₛ_{^{bs}} it means that the current iterative solution is better than the current optimal solution. In step S415, after replacing the current optimal solution s^{bs} with the current iterative solution s^{ib}, in step S420, after performing global pheromone update, the solution construction step is executed again until a termination condition is met.

If TWHₛ_{^{ib}} is not greater than TWHₛ_{^{bs}} it means that the current iterative solution is not better than the current optimal solution, and in step S425, 1 is added to the accumulated number of iterations ITCount. Afterwards, in step S430, it is determined whether the accumulated number of iterations ITCount reaches the threshold value RPCount and whether the preset parameter q₀ exceeds the upper limit value qₘₐₓ. If the accumulated number of iterations ITCount does not reach the threshold value RPCount or the preset parameter q₀ exceeds the upper limit value qₘₐₓ (step S430: No), in step S420, after performing global pheromone update, the solution construction step is executed again until the termination condition is met. If the accumulated number of iterations ITCount reaches the threshold value RPCount and the preset parameter q₀ has not exceeded the upper limit qₘₐₓ (step S430: Yes), it means that it is difficult for the ants to find a better solution under the current search strategy setting, then in step S435, the preset parameter q₀ is set higher (for example, q₀←q₀+μ), the pheromone value is initialized (for example, the pheromone value τ is set to the initial value of pheromone τ0), and the accumulated iteration number returns to 0, the search strategy of ants is adjusted iteratively from the random breadth “exploration” to the depth “exploitation”. Afterwards, the solution construction step is executed again until the termination condition is met. The setting of u may be determined by the user, or can be determined through an ACO algorithm.

The following introduces the design concept of the ACO algorithm based on the above, and an example is provided to illustrate the calculation execution of the scheduling solution construction and pheromone update in details.

In this embodiment, the production line j is A5D, the number o of the model set is 11, the scheduled start time (SST₁₁) of the model set 11 is 3000 seconds, and the scheduled completion time (SCT₁₁) is 3720 seconds, the batch data thereof is shown below.

### Batch Data

production line [j]: A5D; model set [o]: 11

| | Representative weight | Production time |
|---|---|---|
| Batch number [k] | [BWTⱼₒₖ] | [BPTⱼₒₖ] |
| A5D_ONL_BA_1 | 2 | 48 |
| A5D_ONL_BA_2 | 1 | 48 |
| A5D_ONL_BA_3 | 2 | 192 |
| A5D_ONL_BA_4 | 2 | 48 |
| A5D_ONL_BA_5 | 1 | 48 |

The initial values are set as follows: τ0=0.01, α=0.7, β=0.3, q₀=0.4, θ=0.7, ρ=0.3, w^{ib}=0.3, w^{bs}=0.7.

The first iteration: j=A5D, o=11, 1=1 (the first sorted position). Based on formula (51), the heuristic value η(j,o,k) corresponding to the current batch k to be scheduled is calculated, that is, η(A5D, 11, k), and then the pheromone value τ(j,o,k, l) is integrated to calculate [τ(j,o,k,l)^{α}·[η(j,o,k)]^{β}, that is, [τ(A5D, 11, k, 1)]^{α}·[η(A5D, 11, k)]^{β}, the result of the first calculation is obtained as follows.

### the First Calculation Result

| Batch [k] | η(j, o, k) | [τ(j, o, k, l)^{α} · [η(j, o, k)]^{β} |
|---|---|---|
| A5D_ONL_BA_1 | 2/48 | 0.037^{0.7} · 0.042^{0.3} = 0.038 |
| A5D_ONL_BA_2 | 1/48 | 0.028^{0.7} · 0.021^{0.3} = 0.026 |
| A5D_ONL_BA_3 | 2/192 | 0.056^{0.7} · 0.01^{0.3} = 0.033 |
| A5D_ONL_BA_4 | 2/48 | 0.014^{0.7} · 0.042^{0.3} = 0.019 |
| A5D_ONL_BA_5 | 1/48 | 0.043^{0.7} · 0.021^{0.3} = 0.035 |

Next, a random random number q=0.314 that conforms to the uniform distribution [0,1] is generated. Since q≤ q₀=0.4, the batch corresponding to the maximum value is selected from among the five [τ(j,o,k,l)^{α}·[η(j,o,k)]^{β} shown in the first calculation result according to formula (52), that is, batch A5D_ONL_BA_1, and is sorted in the first sorted position in the model set 11 on the production line A5D.

After that, the scheduled start time BST and scheduled completion time BCT of the batch AD_ONL_BA_1 are calculated according to formulas (54) and (55).

$$BS {T}_{A 5 {D}_{-} O N {L}_{-} B {A}_{-} 1} = 3000 ;$$

$${BCT}_{A 5 {D}_{-} O N {L}_{-} B {A}_{-} 1} = 3000 + 48 = 3048 .$$

Next, the work orders in the batch A5D_ONL_BA_1 are sorted in non-increasing order according to the corresponding weights, and the scheduled start time (MST ijok) and scheduled completion time (MCTᵢⱼₒₖ) of work order i at each sorted position are calculated using formulas (56) and (57). Then, the pheromone value corresponding to the combination (A5D,11,A5D_ONL_BA_1,1) is updated according to formula (61):

$$( 1 - θ ) \cdot ( A 5 D , 11 , A 5 {D}_{-} O N {L}_{-} B {A}_{-} 1 , 1 ) + θ \cdot τ0 =$$

$$( 1 - 0.7 ) \cdot 0.037 + 0.7 \cdot 0.01 = 0.018 .$$

Second iteration: j=A5D, o=11, 1=2 (2nd sorted position). The heuristic value η(A5D, 11, k) corresponding to the current batch k to be scheduled is calculated based on formula (51), and then the pheromone value τ(j,o,k,l) is integrated to calculate [τ(j,o,k,l)^{α}·[η(j,o,k)]^{β}, that is, [τ(A5D, 11, k, 1)]^{α}·[η(A5D, 11, k)]^{β} to obtain the result of the second calculation as follows.

### The Second Calculation Result

| Batch [k] | η(j, o, k) | [τ(j, o, k, l)^{α} · [η(j, o, k)]^{β} |
|---|---|---|
| A5D_ONL_BA_2 | 1/48 | 0.057^{0.7} · 0.021^{0.3} = 0.042 |
| A5D_ONL_BA_3 | 2/192 | 0.031^{0.7} · 0.01^{0.3} = 0.022 |
| A5D_ONL_BA_4 | 2/48 | 0.089^{0.7} · 0.042^{0.3} = 0.071 |
| A5D_ONL_BA_5 | 1/48 | 0.064^{0.7} · 0.021^{0.3} = 0.046 |

Next, a random random number q=0.605 that conforms to the uniform distribution [0,1] is generated. Since q>q₀=0.4, the probability Pᵣ(k,2) that each batch k in the second calculation result to be correspondingly sorted into the second sorted position in the model set 11 of the production line A5D is calculated according to formula (53), as shown in the probability calculation results below.

### Probability Calculation Result

| Batch [k] | Pᵣ(k, 2) |
|---|---|
| A5D_ONL_BA_2 | 0.042/(0.042 + 0.022 + 0.071 + 0.046) = 0.233 |
| A5D_ONL_BA_3 | 0.022/(0.042 + 0.022 + 0.071 + 0.046) = 0.122 |
| A5D_ONL_BA_4 | 0.071/(0.042 + 0.022 + 0.071 + 0.046) = 0.392 |
| A5D_ONL_BA_5 | 0.046/(0.042 + 0.022 + 0.071 + 0.046) = 0.253 |

Based on the result of the probability calculation, the batch A5D_ONL_BA_5 is randomly selected to be sorted in the second sorted position in the model set 11 of the production line A5D. Afterwards, the scheduled start time BST and scheduled completion time BCT of the batch A5D_ONL_BA_5 are calculated according to formulas (54) and (55).

$$B S {T}_{A 5 {D}_{-} O N {L}_{-} B {A}_{-} 5} = {BCT}_{A 5 D , 11 , A 5 {D}_{-} O N {L}_{-} B {A}_{-} 1} = 3048 ;$$

$${BCT}_{A 5 {D}_{-} O N {L}_{-} B {A}_{-} 5} = 3048 + 48 = 3096 .$$

Next, the work orders in the batch A5D_ONL_BA_5 are sorted in a non-increasing order according to the corresponding weights, and the scheduled start time (MSTᵢⱼₒₖ) and scheduled completion time (MCTᵢⱼₒₖ) of the work order i at each sorted position are calculated using formulas (56) and (57). Then, the pheromone value corresponding to the combination (A5D,11,A5D_ONL_BA_5,2) is updated according to formula (61):

$$( 1 - θ ) \cdot ( A 5 D , 11 , A 5 {D}_{-} O N {L}_{-} B {A}_{-} 5 , 2 ) + θ \cdot τ0 \text{} = ( 1 - 0.7 ) \cdot 0.064 + 0.7 \cdot 0.01 = 0.026 .$$

Third iteration: j=A5D, 0=11, 1=3 (3rd sorted position). Based on formula (51), the third calculation result below is obtained.

### The Third Calculation Result

| Batch [k] | η(j, o, k) | [τ(j, o, k, l)^{α} · [η(j, o, k)]^{β} |
|---|---|---|
| A5D_ONL_BA_2 | 1/48 | 0.055^{0.7} · 0.021^{0.3} = 0.041 |
| A5D_ONL_BA_3 | 2/192 | 0.027^{0.7} · 0.01^{0.3} = 0.02 |
| A5D_ONL_BA_4 | 2/48 | 0.061^{0.7} · 0.042^{0.3} = 0.055 |

Next, a random random number q=0.812 that conforms to the uniform distribution [0,1] is generated. Since q>q₀=0.4, the probability Pᵣ(k,3) that each batch k in the third calculation result to be correspondingly sorted into the third sorted position in the model set 11 of the production line A5D is calculated according to formula (53), as shown in the probability calculation results below.

### Probability Calculation Result

| Batch [k] | Pᵣ(k, 3) |
|---|---|
| A5D_ONL_BA_2 | 0.041/(0.041 + 0.02 + 0.055) = 0.356 |
| A5D_ONL_BA_3 | 0.02/(0.041 + 0.02 + 0.055) = 0.173 |
| A5D_ONL_BA_4 | 0.055/(0.041 + 0.02 + 0.055) = 0.471 |

Based on the result of the probability calculation, the batch A5D_ONL_BA_4 is randomly selected to be sorted in the third sorted position in the model set 11 of the production line A5D. Afterwards, the scheduled start time BST and scheduled completion time BCT of the batch A5D_ONL_BA_4 are calculated according to formulas (54) and (55).

$$BS {T}_{A 5 {D}_{-} O N {L}_{-} B {A}_{-} 4} = {BCT}_{A 5 D , 11 , A 5 {D}_{-} O N {L}_{-} B {A}_{-} 5} = 3096 ;$$

$${BCT}_{A 5 {D}_{-} O N {L}_{-} B {A}_{-} 4} = 3096 + 48 = 3144.$$

Next, the work orders in the batch A5D_ONL_BA_4 are sorted in a non-increasing order according to the corresponding weights, and the scheduled start time (MSTᵢⱼₒₖ) and scheduled completion time (MCTᵢⱼₒₖ) of the work order i at each sorted position are calculated using formulas (56) and (57). Then, the pheromone value corresponding to the combination (A5D,11,A5D_ONL_BA_4,3) is updated according to formula (61):

$$( 1 - θ ) \cdot ( A 5 D , 11 , A 5 {D}_{-} O N {L}_{-} B {A}_{-} 4 , 3 ) + θ \cdot τ0 = ( 1 - 0.7 ) \cdot 0.061 + 0.7 \cdot 0.01 = 0.0 253.$$

The fourth iteration: j=A5D, o=11, 1=4 (4th sort position). Based on formula (51), the fourth calculation result below is obtained.

### The Fourth Calculation Result

| Batch [k] | η(j, o, k) | [τ(j, o, k, l)^{α} · [η(j, o, k)]^{β} |
|---|---|---|
| A5D_ONL_BA_2 | 1/48 | 0.076^{0.7} · 0.021^{0.3} = 0.052 |
| A5D_ONL_BA_3 | 2/192 | 0.058^{0.7} · 0.01^{0.3} = 0.034 |

Next, a random random number q=0.215 that conforms to the uniform distribution [0,1] is generated. Since q≤ q₀=0.4, the batch corresponding to the maximum value is selected from among the two [τ(j,o,k,l)^{α}·[η(j,o,k)]^{β} in the fourth calculation result according to formula (52), that is, the batch A5D_ONL_BA_2, which is sorted at the fourth sorted position in the model set 11 of the production line A5D.

Afterwards, the scheduled start time BST and scheduled completion time BCT of the batch A5D_ONL_BA_2 are calculated according to formulas (54) and (55).

$$B S {T}_{A 5 {D}_{-} O N {L}_{-} B {A}_{-} 2} = B C {T}_{A 5 {D}_{-} O N {L}_{-} B {A}_{-} 4} = 3144 ;$$

$${BCT}_{A 5 {D}_{-} O N {L}_{-} B {A}_{-} 2} = 3144 + 48 = 3192 .$$

Next, the work orders in the batch A5D_ONL_BA_2 are sorted in a non-increasing order according to the corresponding weight, and the scheduled start time (MSTᵢⱼₒₖ) and scheduled completion time (MCTᵢⱼₒₖ) of the work order i at each sorted position are calculated by using formulas (56) and (57). Then, the pheromone value corresponding to the combination (A5D,11,A5D_ONL_BA_2,4) is updated according to formula (61):

$$( 1 - θ ) \cdot ( A 5 D , 11 , A 5 {D}_{-} O N {L}_{-} B {A}_{-} 2 , 4 ) + θ \cdot τ0 = ( 1 - 0.7 ) \cdot 0.076 + 0.7 \cdot 0.01 = 0.0298 .$$

The fifth iteration: j=A5D, o=11, 1=5 (the 5th sorted position). The batch A5D_ONL_BA_3 is sorted in the fifth sorted position in the model set 11 of the production line A5D. The scheduled start time BST and scheduled completion time BCT of the batch A5D_ONL_BA_3 are calculated according to formulas (54) and (55).

$$B S {T}_{A 5 {D}_{-} O N {L}_{-} B {A}_{-} 3} = B C {T}_{A 5 {D}_{-} O N {L}_{-} B {A}_{-} 2} = 3192 ;$$

$${BCT}_{A 5 {D}_{-} O N {L}_{-} B {A}_{-} 3} = 3191 + 192 = 3384 .$$

Next, the work orders in the batch A5D_ONL_BA_3 are sorted in a non-increasing order according to the corresponding weight, and the scheduled start time (MSTᵢⱼₒₖ) and scheduled completion time (MCTᵢⱼₒₖ) of the work order i in each sorted position are calculated by using formulas (56) and (57). Then, the pheromone value corresponding to the combination (A5D,11,A5D_ONL_BA_3,5) is updated according to formula (61):

$$( 1 - θ ) \cdot ( A 5 D , 11 , A 5 {D}_{-} O N {L}_{-} B {A}_{-} 3 , 5 ) + θ \cdot τ0 = ( 1 - 0.7 ) \cdot 0.056 + 0.7 \cdot 0.01 = 0.0238 .$$

It can be seen from the above calculation steps that when the ant adds the combination (A5D, 11, k, l) to the currently constructed partial scheduling solution in accordance with the pseudo-random-proportional rule, the “local pheromone update” will be executed to reduce the pheromone value corresponding to the combination to prevent the search behavior of ants from tending to choose this combination subsequently due to the influence of the pheromone value, thus ensuring the diversity of search behavior. When the batches and work orders on all production lines have been scheduled and planned according to the above steps, it means that ants have completed the construction of the solution. Then, formulas (58) to (60) are utilized to calculate the total weighted work order completion rate corresponding to the scheduling solution of the group. In the meantime, a “global pheromone update” is performed for all combinations (A5D,11,k,l) to enhance the search behavior of ants, that is, depth “exploitation”.

Based on the first iteration to the fifth iteration above, the following combination numbers may be obtained in the current iteration solution s^{ib}:
{(A5D,11,A5D_ONL_BA_1,1), (A5D,11,A5D_ONL_BA_5,2), (A5D,11,A5D_ONL_BA_2,4), (A5D,11,A5D_ONL_BA_4,3), (A5D,11,A5D_ONL_BA_3,5)}.

(j . . . l) is set according to formula (62), as shown below.

Production line [j]: A5D; model set [o]: 11

| Batch [k] | Sorted position [l] | C^{ib}(A5D, 11, k, l) |
|---|---|---|
| A5D_ONL_BA_1 | 1 | 1 |
| | 2 | 0 |
| | 3 | 0 |
| | 4 | 0 |
| | 5 | 0 |
| A5D_ONL_BA_2 | 4 | 1 |
| | 1 | 0 |
| | 2 | 0 |
| | 3 | 0 |
| | 5 | 0 |
| A5D_ONL_BA_3 | 5 | 1 |
| | 1 | 0 |
| | 2 | 0 |
| | 3 | 0 |
| | 4 | 0 |
| A5D_ONL_BA_4 | 3 | 1 |
| | 1 | 0 |
| | 2 | 0 |
| | 4 | 0 |
| | 5 | 0 |
| A5D_ONL_BA_5 | 2 | 1 |
| | 1 | 0 |
| | 3 | 0 |
| | 4 | 0 |
| | 5 | 0 |

The combination corresponding to the current optimal solution s^{bs} is set as:
{(A5D, 11,A5D_ONL_BA_1,1), (A5D,11,A5D_ONL_BA_2,3), (A5D, 11,A5D_ONL_BA_5,2), (A5D,11,A5D_ONL_BA_4,4), 5 (A5D,11,A5D_ONL_BA_3,5)}.

C^{b}^{^{s}}(j,o,k,l) is set according to formula (63), as shown below.

Production line [j]: A5D; model set [o]: 11

| Batch [k] | Sorted position [l] | C^{b}^{^{s}}(A5D, 11, k, l) |
|---|---|---|
| A5D_ONL_BA_1 | 1 | 1 |
| | 2 | 0 |
| | 3 | 0 |
| | 4 | 0 |
| | 5 | 0 |
| A5D_ONL_BA_2 | 3 | 1 |
| | 1 | 0 |
| | 2 | 0 |
| | 4 | 0 |
| | 5 | 0 |
| A5D_ONL_BA_3 | 5 | 1 |
| | 1 | 0 |
| | 2 | 0 |
| | 3 | 0 |
| | 4 | 0 |
| A5D_ONL_BA_4 | 4 | 1 |
| | 1 | 0 |
| | 2 | 0 |
| | 3 | 0 |
| | 5 | 0 |
| A5D_ONL_BA_5 | 2 | 1 |
| | 1 | 0 |
| | 3 | 0 |
| | 4 | 0 |
| | 5 | 0 |

The pheromone value corresponding to each combination (A5D, 11, k, l) is updated according to formula (64) as follows.

Production line [j]: A5D; model [o]: 11

| Batch [k] | [l] | τ(A5D, 11, k, l) |
|---|---|---|
| A5D_ONL_BA_1 | 1 | =0.018 + 0.3 · (0.3 · 1 + 0.7 · 1-0.018) = 0.3126 |
| | 2 | =0.052 + 0.3 · (0.3 · 0 + 0.7 · 0-0.052) = 0.0364 |
| | 3 | =0.06 + 0.3 · (0.3 · 0 + 0.7 · 0-0.06) = 0.042 |
| | 4 | =0.014 + 0.3 · (0.3 · 0 + 0.7 · 0-0.014) = 0.0098 |
| | 5 | =0.083 + 0.3 · (0.3 · 0 + 0.7 · 0-0.083) = 0.0581 |
| A5D_ONL_BA_2 | 1 | =0.028 + 0.3 · (0.3 · 0 + 0.7 · 0-0.028) = 0.0196 |
| | 2 | =0.057 + 0.3 · (0.3 · 0 + 0.7 · 0-0.057) = 0.0399 |
| | 3 | =0.055 + 0.3 · (0.3 · 0 + 0.7 · 1-0.057) = 0.2479 |
| | 4 | =0.0298 + 0.3 · (0.3 · 1 + 0.7 · 0-0.0298) = 0.11086 |
| | 5 | =0.074 + 0.3 · (0.3 · 0 + 0.7 · 0-0.074) = 0.0518 |
| A5D_ONL_BA_3 | 1 | =0.056 + 0.3 · (0.3 · 0 + 0.7 · 0-0.056) = 0.0392 |
| | 2 | =0.031 + 0.3 · (0.3 · 0 + 0.7 · 0-0.031) = 0.0217 |
| | 3 | =0.027 + 0.3 · (0.3 · 0 + 0.7 · 0-0.027) = 0.0189 |
| | 4 | =0.058 + 0.3 · (0.3 · 0 + 0.7 · 0-0.058) = 0.0406 |
| | 5 | =0.0238 + 0.3 · (0.3 · 1 + 0.7 · 1-0.0238) = 0.31666 |
| A5D_ONL_BA_4 | 1 | =0.014 + 0.3 · (0.3 · 0 + 0.7 · 0-0.014) = 0.0098 |
| | 2 | =0.089 + 0.3 · (0.3 · 0 + 0.7 · 0-0.089) = 0.0623 |
| | 3 | =0.0253 + 0.3 · (0.3 · 1 + 0.7 · 0-0.0253) = 0.10771 |
| | 4 | =0.067 + 0.3 · (0.3 · 0 + 0.7 · 1-0.067) = 0.2569 |
| | 5 | =0.029 + 0.3 · (0.3 · 0 + 0.7 · 0-0.029) = 0.0203 |
| A5D_ONL_BA_5 | 1 | =0.043 + 0.3 · (0.3 · 0 + 0.7 · 0-0.043) = 0.0301 |
| | 2 | =0.026 + 0.3 · (0.3 · 1 + 0.7 · 1-0.026) = 0.3182 |
| | 3 | =0.079 + 0.3 · (0.3 · 0 + 0.7 · 0-0.079) = 0.0553 |
| | 4 | =0.024 + 0.3 · (0.3 · 0 + 0.7 · 0-0.024) = 0.0168 |
| | 5 | =0.056 + 0.3 · (0.3 · 0 + 0.7 · 0-0.056) = 0.0392 |

Based on the above calculation steps, it can be found that if the combination corresponding to the current iterative solution s^{ib} is also the current optimal solution s^{bs}, the corresponding pheromone value will increase, so that there is a higher probability for ants to select this combination subsequently when constructing a scheduling solution; otherwise, if the combination does not belong to the current iterative solution s^{ib} and the current best solution s^{bs}, the corresponding pheromone value will decrease, reducing the probability for the ants to select the combination subsequently when constructing the scheduling solution.

In an embodiment, an application program with a user interface may be set in the intelligent scheduling system 100 for the user to use. After the user completes the data input through the user interface, the application programming interface (API) will automatically call CPLEX for planning and solving. The CPLEX solution engine uses the branch-and-cut algorithm as the main framework to solve the model. The algorithm uses the branch-and-bound algorithm to split the original problem into multiple independent sub-problems, and uses primal/dual simplex algorithm to solve the sub-problem of linear programming relaxation. If the decision variable restricted to an integer is a non-integer value after the optimal solution is obtained, the algorithm will use the cutting plane method to further derive the linear constraint formula to be added to the current linear programming relaxation problem, so that the solution obtained by next iteration may be closer to an integer solution.

CPLEX may further optimize solution efficiency through parameter settings such as preprocessing, branching strategy, search strategy (such as depth-first search, breadth-first search, best-first search), heuristic method and so on.

In the following, an example is given for verification, in which the “electronic manufacturing service industry” is set as the object, and then appropriate corrections may be made according to the environmental assumptions to facilitate the verification and execution of various functional modules. In this example, CPLEX is used to construct the models of the work order assignment module 121 and the work order form batching module 122, and Python is used to construct the work order detailed scheduling module 123.

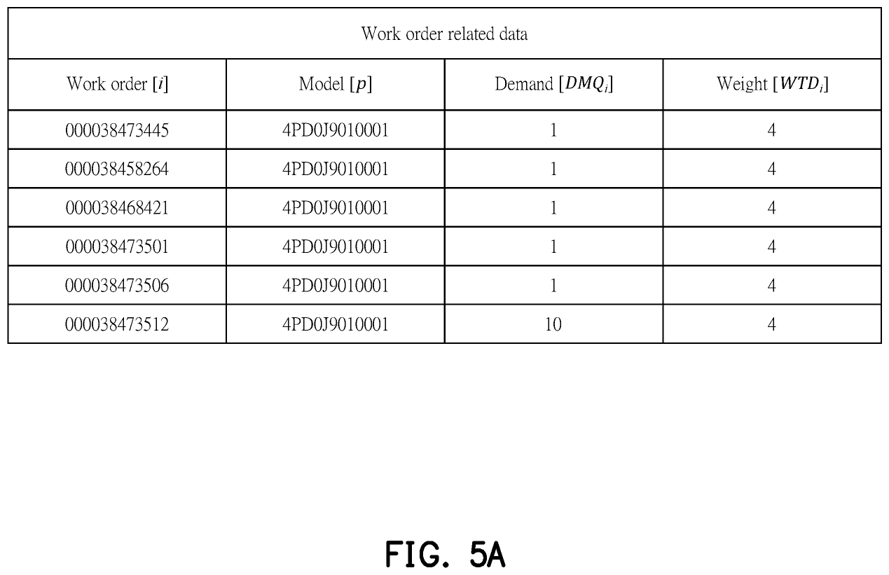

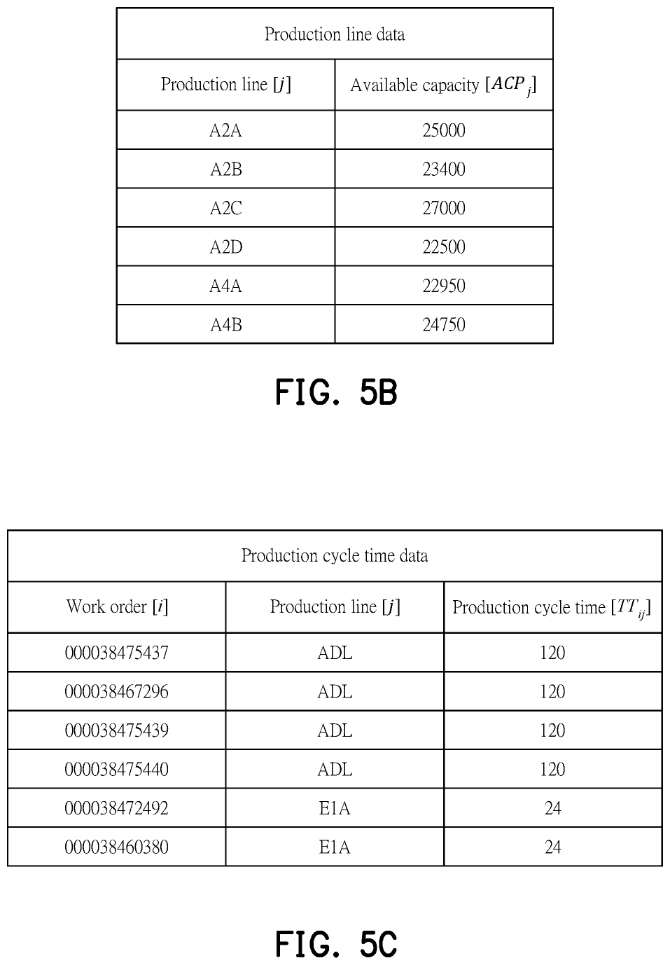

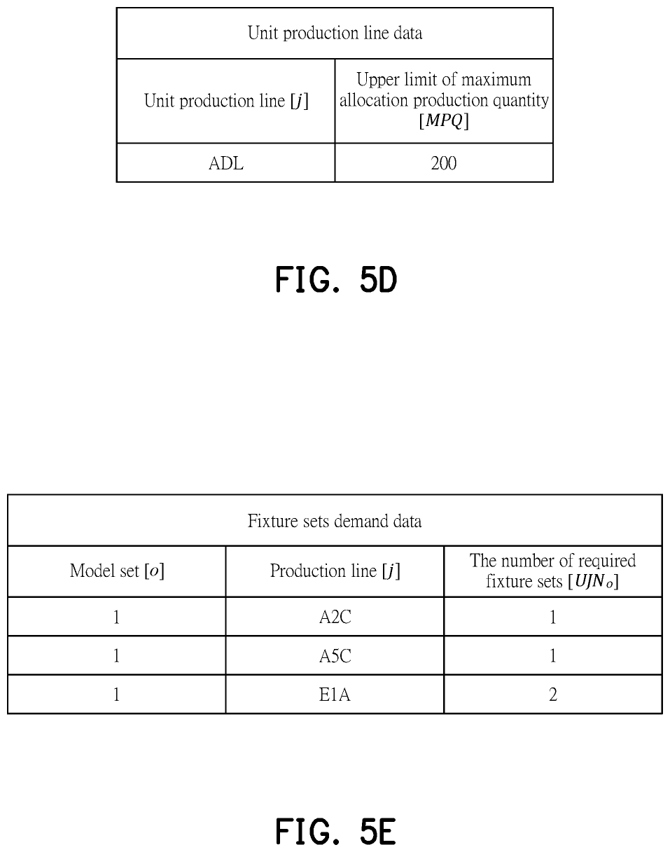

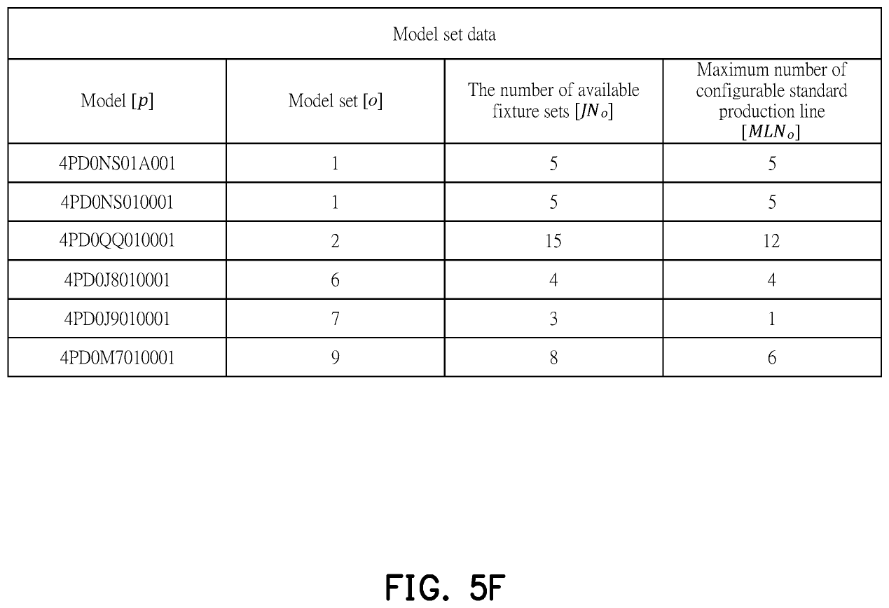

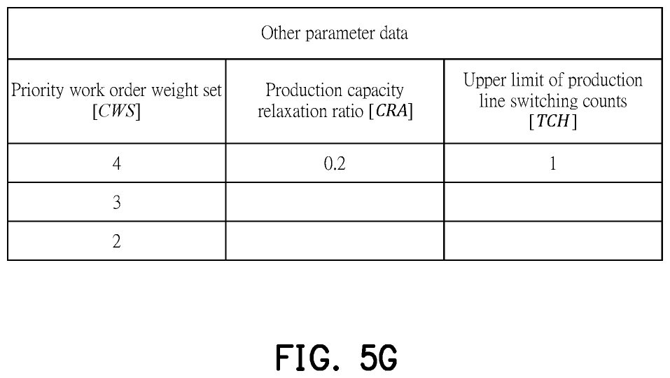

FIG. 5A-FIG. 5G are schematic diagrams of scheduling-related data according to an embodiment of the present disclosure. FIG. 5A shows work order data. For example, the model corresponding to work order 000038473445 is 4PD0J9010001, the demand is 1, and the weight is 4. FIG. 5B shows the production line data. For example, the available capacity seconds of production line A2A is 25000 seconds. FIG. 5C shows the production cycle time data. For example, the production cycle time of the work order 000038475437 in the production line ADL is 120 seconds. FIG. 5D shows the unit line data. FIG. 5E shows the data of the number of required fixture sets. For example, 1 set of fixture is required for the production of model set 1 in production line A2C.

FIG. 5F shows the model set data, for example, the same model set 1 corresponding to the model 4PDONS01A001 and the model 4PDONS010001. The number of available fixture sets corresponding to model set 1 is 5, and the maximum number of configurable standard production lines is 5. FIG. 5G shows other parameter data, which lists the priority work order weight set as {2,3,4}, the capacity relaxation ratio of each production line is 0.2, and the upper limit of line switching counts of each production line is 1.

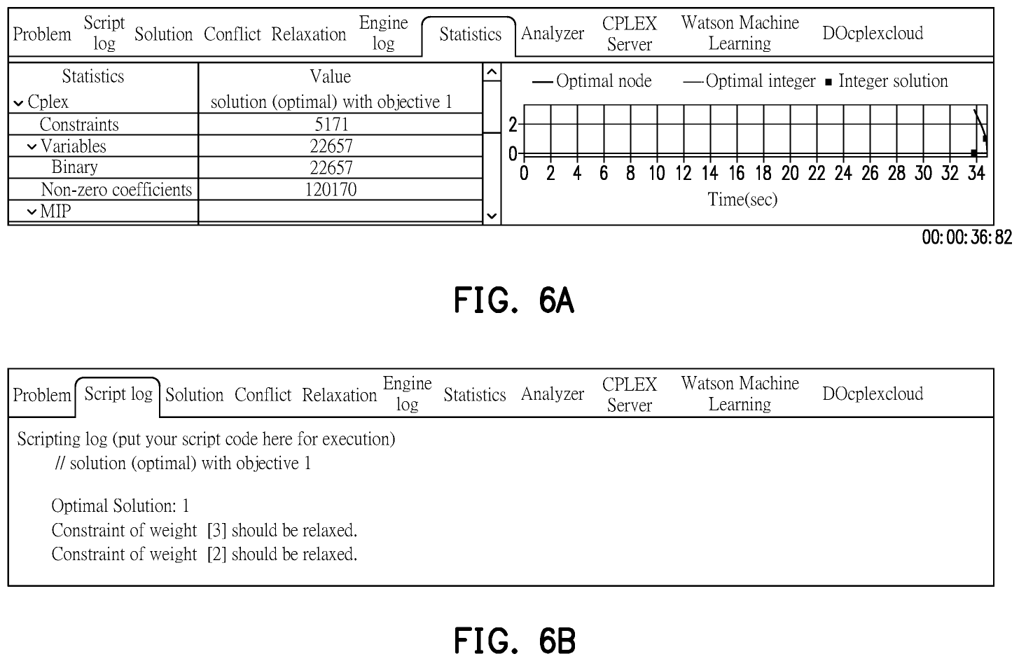

FIG. 6A and FIG. 6B are schematic diagrams of a user interface according to an embodiment of the present disclosure. FIG. 6A shows “Statistics” page of CPLEX's solution-related information. The table on the left includes two columns, “Statistics” and “Value”. The parameter “solution (optimal) with objective 1” represents that the optimal objective function value for solving the example problem is 1. The column “Statistics” includes the following items: “Constraints” represents the total number of mathematical model constraints for solving the example problem, and the corresponding value is 5171; “Variables” represents the total number of decision variables of the mathematical model for solving the example problem, and the corresponding value is 22657; “Binary” represents the total number of binary decision variables of the mathematical model for solving the example problem, and the corresponding value is 22657; “Non-zero coefficients” represents the total number of non-zero coefficients of the mathematical model for solving the example problem, and the corresponding value is 120170.

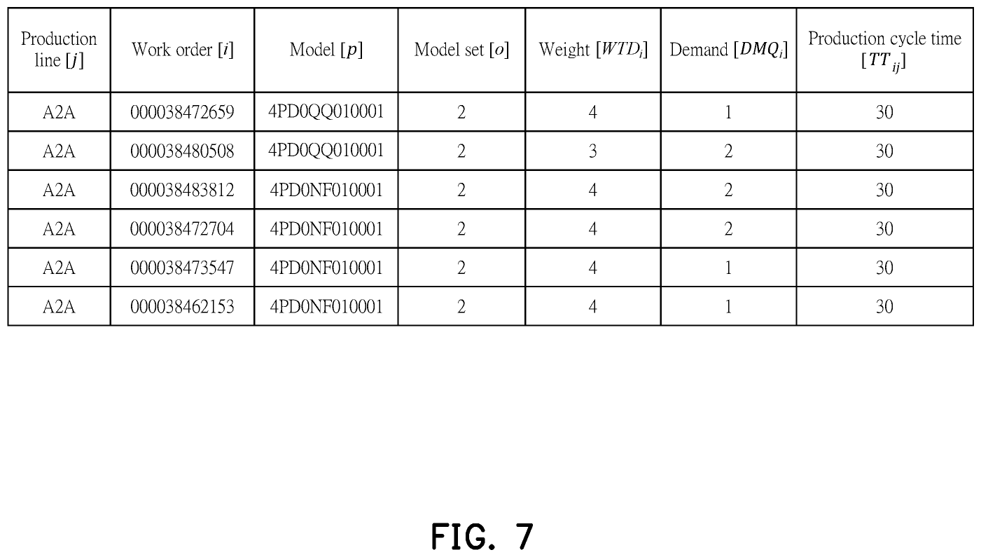

FIG. 6B shows the “Script Log” page, and displays feedback information. For example, the feedback information includes work orders in the priority work order weight set that cannot be assigned. Here, the “Script Log” page shows: the optimal objective function value is 1 (“Optimal Solution: 1”), which means that only work orders corresponding to weight 4 in the priority work order weight set {2,3,4} are able to be assigned. Therefore, the “Script Log” page in the user interface further displays the script commands that the work order assignment constraint corresponding to weight 3 and weight 2 need to be relaxed, such as “Constraint of Weight [3] should be relaxed”, “Constraint of Weight [2] should be relaxed”. Accordingly, the system automatically adjusts the priority work order weight set to {4}, and performs assignment model 213 to solve. After that, the report data as shown in FIG. 7 is obtained. FIG. 7 is a schematic diagram of work order assignment report data according to an embodiment of the present disclosure. For example, the work order 000038472659 is assigned to the production line A2A, corresponding to the model 4PD0QQ010001, the number of the model set is 2, the weight is 4, and the demand is 1. The production cycle time of this work order in the assigned production line is 30 seconds.

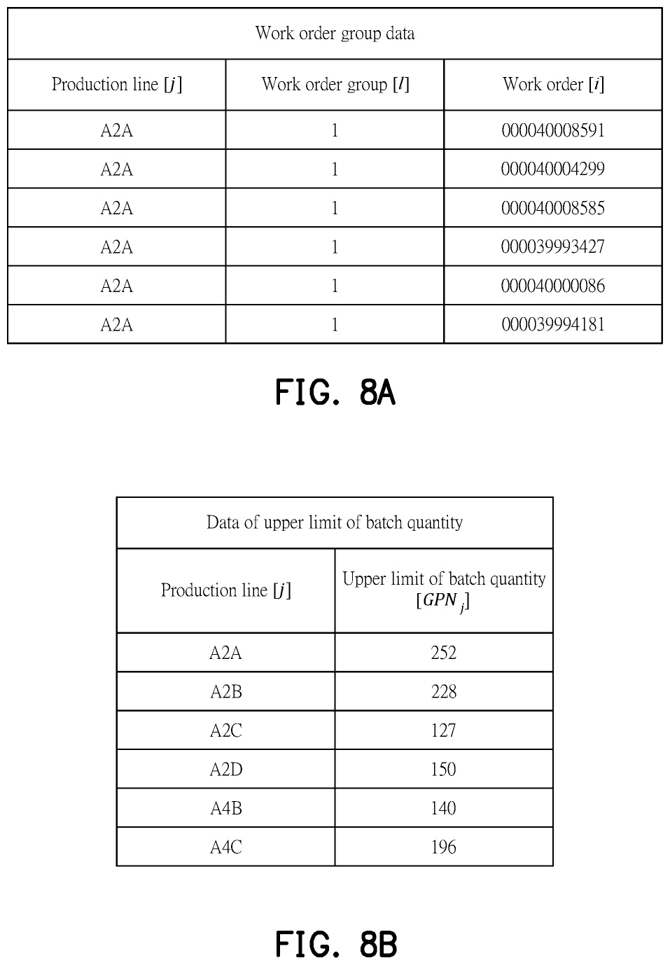

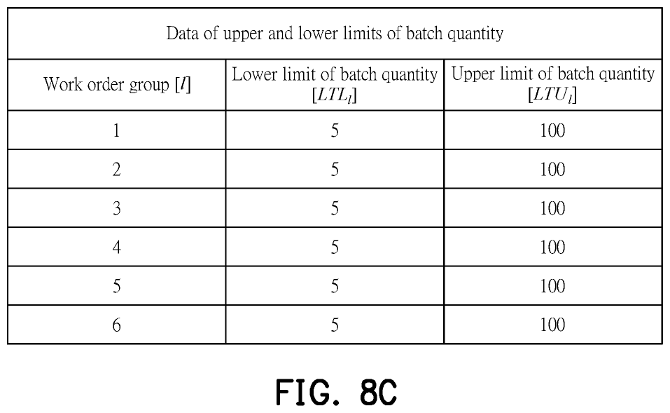

FIG. 8A to FIG. 8C are schematic diagrams of form batching-related data according to an embodiment of the present disclosure. FIG. 8A shows work order group data. The work order group field is the group number formed by the work orders with the same attribute and assembled into the same batch. For example, the six work orders listed in FIG. 8A are all assigned to the production line A2A, and all belong to the work order group 1, which means it may be considered that these six work orders may be grouped into the same batch. FIG. 8B shows the data related to upper limit of batch quantity. For example, the upper limit of batch quantity corresponding to production line A2A is 252. FIG. 8C shows the data related to upper and lower limits of batch quantity. For example, the lower limit of batch quantity for work order group 1 is 5, and the upper limit of batch quantity is 100.

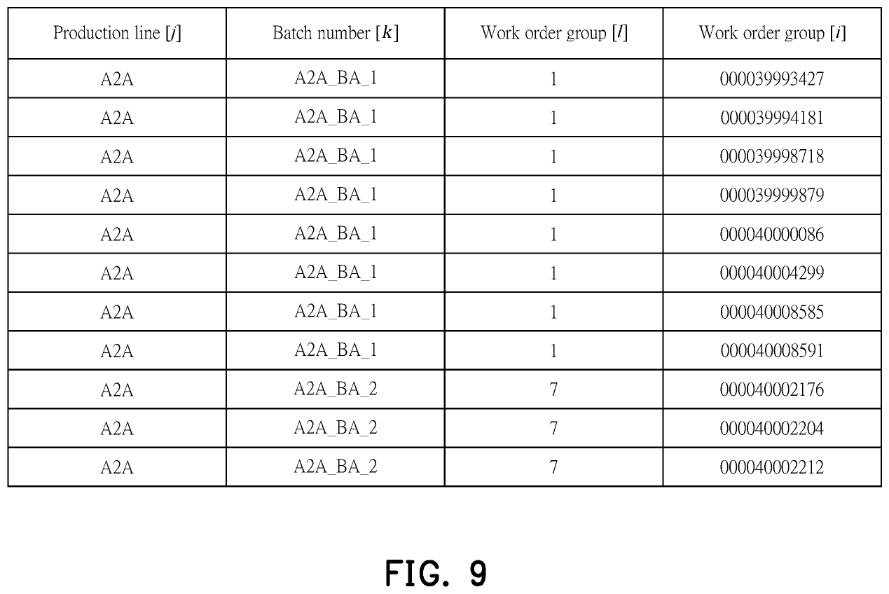

FIG. 9 is a schematic diagram of work order form batching report data according to an embodiment of the present disclosure. Please refer to FIG. 9, in production line A2A, work orders 000039993427, 000039994181, 000039998718, 000039999879, 000040000086, 000040004299, 000040008585, and 000040008591 belong to the work order group 1, and they are assembled into batch number A2A_BA_1. In addition, work orders 000040002176, 000040002204, and 000040002212 belong to work order group 7, and they are assembled into batch number A2A_BA_2.

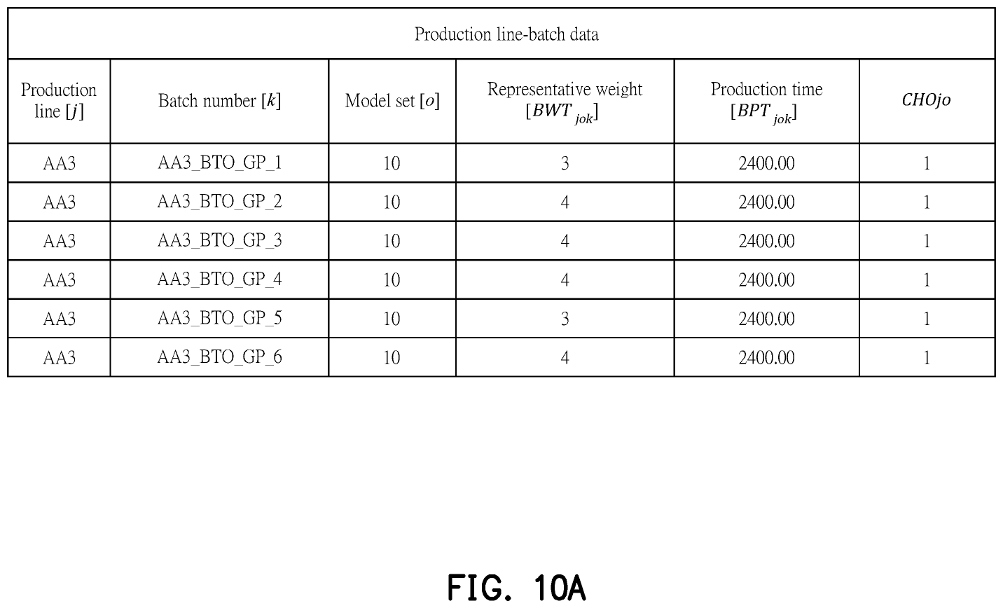

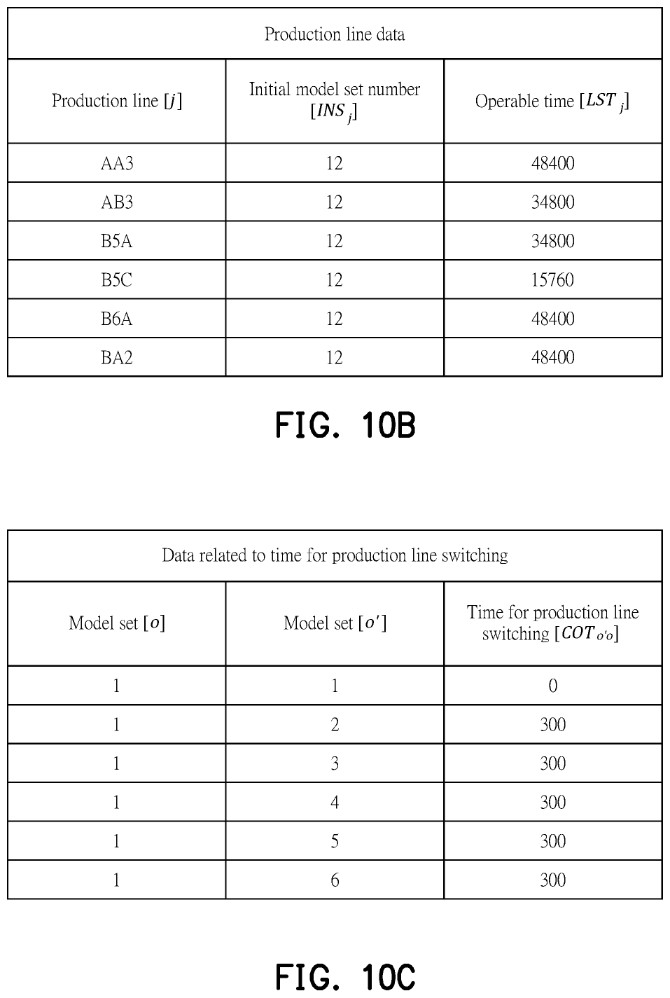

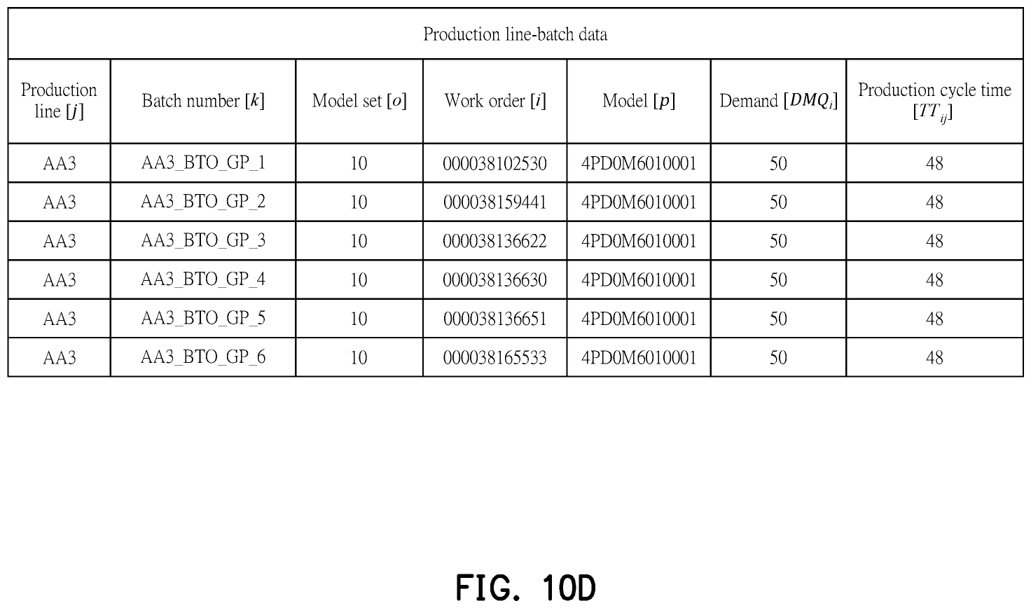

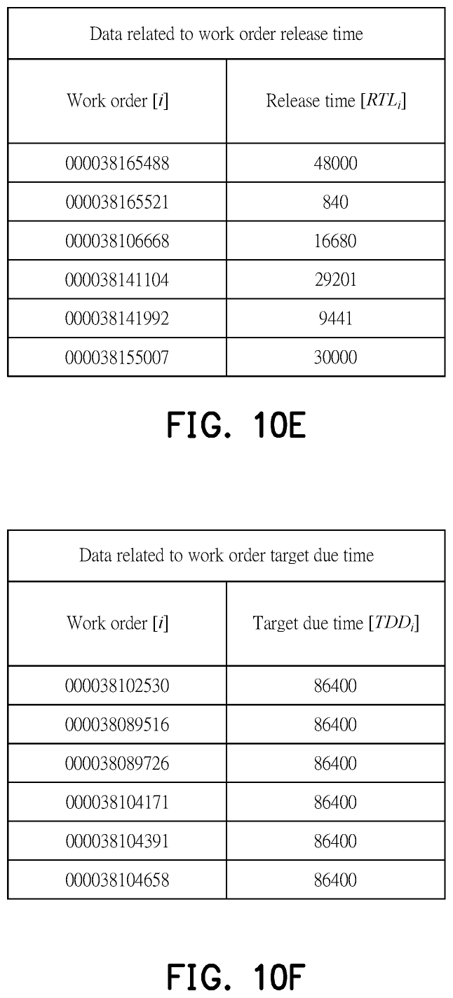

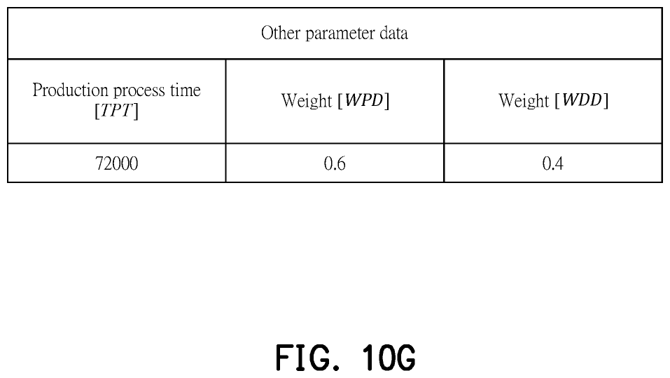

FIG. 10A to FIG. 10G are schematic diagrams of detailed scheduling data according to an embodiment of the present disclosure. FIG. 10A shows the data related to production line batch. For example, the batch AA3_BTO_GP_1 corresponding to the production line AA3 belongs to the model set 10. The representative weight of batch AA3_BTO_GP_1 is 3, the production time is 2400 seconds, and production line switching may not be required when model set 10 is assigned to the production line AA3.

FIG. 10B shows data related to production line. For example, the initial model set number of production line AA3 is 12, and the operable time is 48400 seconds. FIG. 10C shows the data related to time for production line switching. For example, the time required for switching production line from model set 2 to model set 1 is 300 seconds. FIG. 10D shows the data related to production line-batch work order. For example, the batch AA3_BTO_GP_1 corresponding to the production line AA3 belongs to the model set 10. Batch AA3_BTO_GP_1 contains work order 000038102530, the work order corresponds to model 4PD0M6010001, the demand is 50, and the production cycle time is 48 seconds.

FIG. 10E shows data related to work order release time. For example, the release time for work order 000038165488 is 48000 seconds. FIG. 10F shows data related to work order target due time. For example, the target due time of work order 000038102530 is 86400 seconds. FIG. 10G shows other parameter data. The TPT field shows that the target production process time of the work order is 72000 seconds. The WPT field shows that the work order set that achieves the target production process time corresponds to a weight of 0.6. The WDD field shows that the work order set that completes work before the target due date corresponds to a weight of 0.4.

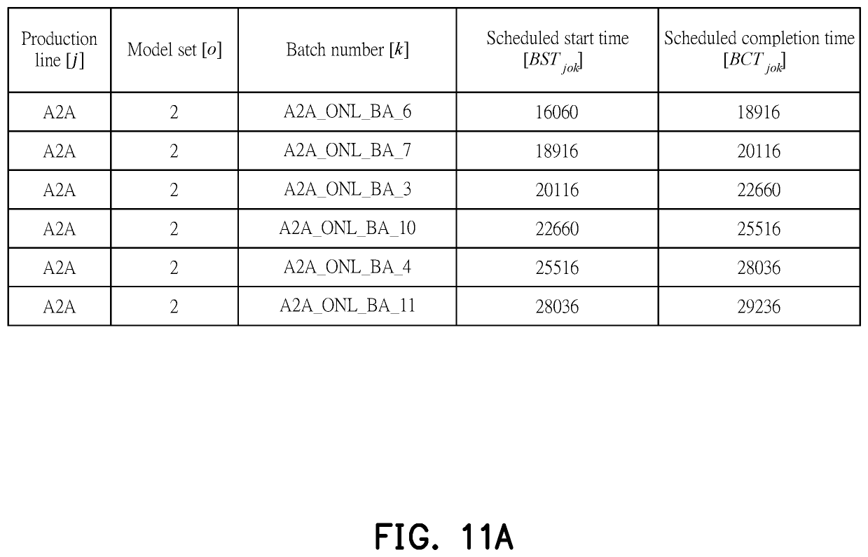

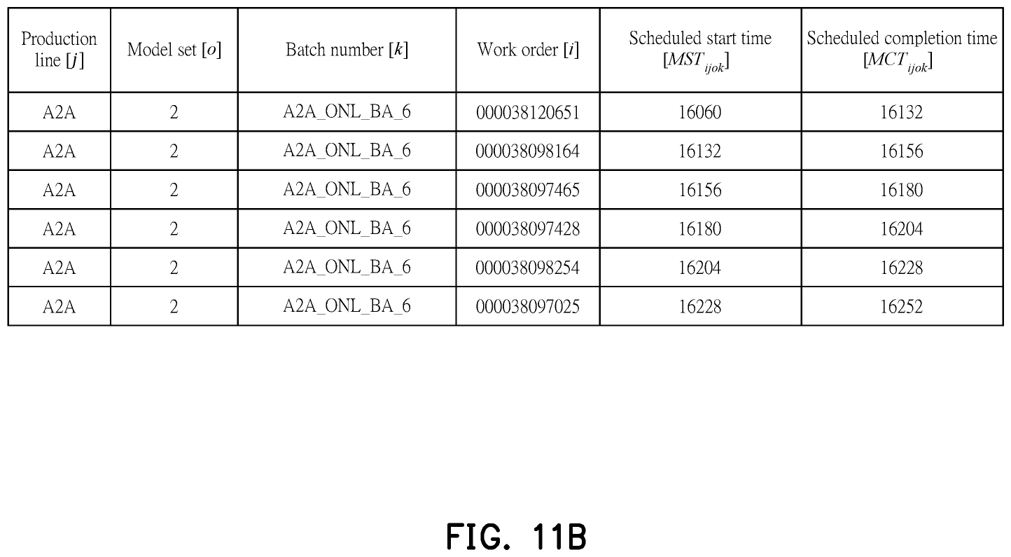

Through the work order detailed scheduling module 123, the report data shown in FIG. 11A and FIG. 11B may be obtained. FIG. 11A and FIG. 11B are schematic diagrams of scheduling report data according to an embodiment of the present disclosure. FIG. 11A shows the data related to batch scheduling report. The data related to batch scheduling report is provided to assign the scheduled start time and scheduled completion time corresponding to each batch number in the model set to which each production line belongs. For example, in production line A2A, the scheduled start time of batch A2A_ONL_BA_6 belonging to model set 2 is 16060 seconds, and the scheduled completion time is 18916 seconds.

FIG. 11B shows data related to work order scheduling report. The data related to work order scheduling report is provided to assign the scheduled start time and scheduled completion time corresponding to each work order number in each batch number in the model set to which each production line belongs. For example, in production line A2A, work order 000038120651 of batch A2A_ONL_BA_6 belonging to model set 2 has a scheduled start time of 16060 seconds and a scheduled completion time of 16132 seconds.

To sum up, the intelligent scheduling system disclosed in this disclosure is able to quickly and timely feedback the optimal work order assignment plan. After the introduction of the above-mentioned intelligent scheduling system, not only can the scheduling decision be optimized, the production line switching counts may be reduced to improve the utilization rate of production capacity. In the meantime, after automation of the process, the overtime hours of the material preparation personnel may be shortened, and the cost of direct labor (DL) may be saved. In addition, after systematization, manpower planning and scheduling are not required, so that cost of indirect labor (IDL) may be saved. This disclosure is able to perform timely re-planning and provide solution in response to changes in customer order requirements or manufacturing resource conditions, thereby ensuring that system users are able to find the optimal or near-optimal ideal production schedule plan within a reasonable time to effectively meet customers' needs and requirement of orders. Accordingly, it is possible to effectively assist enterprises to solve the problems they encounter.

The disclosed disclosure is applicable for customers to arrange work order production schedule plans. Based on work order production requirements and manufacturing operation-related resource constraints, this system may be executed to generate work order production schedule plans within a reasonable time as a decision-making basis for production and operation management. The mathematical model and heuristic algorithm in the embodiment are highly versatile and may be introduced and applied to other groups. The product may also be authorized to customers for use after achieving a certain stability. The present disclosure is suitable for use in 3C manufacturing industry, packaging and testing, processing industry, assembly industry, automobile industry, new energy industry, manufacturing industry, paper industry and other industries.

What is claimed is:

1. An intelligent scheduling method, which utilizes a processor to execute a work order assignment module, a work order form batching module and a work order detailed scheduling module, wherein the intelligent scheduling method comprises:
A. assigning a plurality of work orders to one of a plurality of production lines respectively through the work order assignment module;
B. performing a form batch for the work orders assigned to each of the production lines through the work order form batching module, the work orders are divided into a plurality of work order groups;
C. solving for each of the work orders comprised in each batch of each of the production lines through the work order detailed scheduling module to obtain a schedule plan, wherein the schedule plan comprises a production line assigned for each of the work orders and an operation sequence; and
D. transmitting the schedule plan to an output device.

2. The intelligent scheduling method according to claim 1, wherein step A comprises step A1 and step A2,
in step A1, executing an assignment model comprises: based on a first objective function, satisfying a plurality of first limiting conditions, assigning each of work orders whose weight conforming to a priority work order weight set to one of the production lines, and obtaining a priority work order assignment plan;
wherein the first objective function is set to maximize a total weighted work order assignment quantity, and the first limiting conditions comprise:
1-1. limiting each of the work orders whose weight conforming to the priority work order weight set is assigned to a production line;
1-2. limiting upper and lower limits of the number of model sets assigned to each of the production lines;
1-3. directed at each model set assigned to each of the production lines, limiting upper and lower limits of the number of work orders that simultaneously exist in a work order set corresponding to each model comprised in each of the model sets and a work order set produced by a production line assigned for the model,
1-4. limiting the number of fixtures required for production of each of the model sets in the corresponding assigned production line;
1-5. limiting that a total amount of work order production for each unit production line set does not exceed an upper limit of maximum allocation production quantity;
1-6. limiting a maximum number of configurable standard production lines for each of the model sets; and
1-7. limiting an upper limit of a production time of the work orders comprised in each of the production lines; and
in step A2, executing a production line switching counts optimization model comprises: based on a second objective function, satisfying a plurality of second limiting conditions, limiting a production line switching count of each of the production lines,
wherein the second objective function is set to minimize a total standard production line switching counts, and the second limiting conditions comprise:
2-1. limiting that a sum of a production allocation quantity of the work order satisfies a target production quantity;
2-2. limiting a production line switching count for each of the production lines;
2-3. satisfying the priority work order assignment plan planned by the assignment model;
2-4. limiting the upper and lower limits of the number of model sets assigned to each of the production lines;
2-5. directed at each of the model sets assigned to each of the production lines, limiting the upper and lower limits of the number of the work orders that simultaneously exist in the work order set corresponding to each of the models comprised in each of the model sets and the work order set produced by the production line assigned for the model,
2-6. limiting the number of the fixtures required for the production of each of the model sets in the corresponding assigned production line;
2-7. limiting that the total amount of work order production for each of the unit production line sets does not exceed the upper limit of maximum allocation production quantity;
2-8. limiting a maximum number of the configurable standard production lines for each of the model sets; and
2-9. limiting the upper limit of the production time of the work orders comprised in each of the production lines.

3. The intelligent scheduling method according to claim 2, wherein step A further comprises step A0, and step A0 is before step A1,
in step A0, executing a priority weight evaluation model comprises:
based on a third objective function, satisfying a plurality of third limiting conditions, determining whether each of the work orders in the priority work order weight set is assigned to the corresponding production line,
in response to each of the work orders in the priority work order weight set being assigned to the corresponding production line, executing the step A1; and
in response to at least one of the work orders in the priority work order weight set being unable to be assigned to the corresponding production line, displaying a feedback information on a user interface,
wherein the third objective function is to maximize a total number of priority weights, and the third limiting conditions comprise:
3-1. limiting that each of the work orders whose weight conforms to the priority work order weight set is assigned to a production line;
3-2. limiting each of the work orders to be assigned to one production line at most;
3-3. limiting the upper and lower limits of the number of model sets assigned to each of the production lines;
3-4. directed at each of the model sets assigned to each of the production lines, limiting the upper and lower limits of the number of the work orders that simultaneously exist in the work order set corresponding to each of the models comprised in each of the model sets and the work order set produced by the production line assigned for the model,
3-5. limiting the number of the fixtures required for the production of each of the model sets in the corresponding assigned production line;
3-6. limiting that the total amount of work order production for each of the unit production line sets does not exceed the upper limit of the maximum allocation production quantity;
3-7. limiting the maximum number of the configurable standard production lines for each of the model sets; and
3-8. limiting the upper limit of the production time of the work orders comprised in each of the production lines.

4. The intelligent scheduling method according to claim 3, wherein after displaying the feedback information on the user interface, the method further comprising:
re-adjusting the priority work order weight set through the user interface, and re-executing the priority weight evaluation model;
wherein, the feedback information shows work orders in the priority work order weight set that are unable to be assigned.

5. The intelligent scheduling method according to claim 1, wherein step B comprises:
based on a fourth objective function, and satisfying a plurality of fourth limiting conditions, performing form batching for a plurality of work orders among the work orders comprised in a plurality of batches with the same attribute into a work order group based an attribute of each of the work orders,
wherein the fourth objective function is to minimize a total number of batches under a goal of maximizing the number of form batched total weighted work orders, and the fourth limiting conditions comprise:
4-1. limiting each of the work orders in each of the production lines to be assigned to one of the batches at most, and the number of batches comprised in each of the production lines does not exceed an upper limit of the number of batches;
4-2. limiting each of the batches in each of the production lines to belong to one of the work order groups at most;
4-3. determining whether the batch in each of the production lines belong to any one of the work order groups, generate a next batch in response to it is determined that the current batch belongs to any one of the work order groups;
4-4. directed at each work order group comprised in a work order group number set corresponding to each of the production lines, limiting upper and lower limits of the number of work orders in a work order set corresponding to each of the work order groups;
4-5. limiting that a total demand quantity of a work order demand meets upper and lower limits of a batch quantity.

6. The intelligent scheduling method according to claim 1, wherein step C comprises a calculation step of a first stage, which comprises:
the production lines are categorized into a first category set and a second category set, wherein a model set that is assigned into a production line of the first category set does not need to be switched to another production line, a model set assigned to a production line in the second category set needs to be switched to another production line;
the model sets comprised in each of the first category set and the second category set are sorted in a non-increasing sequence based on their own representative weight;
wherein for the first category set, based on a sorted result of each of the model sets, a scheduled start time and a scheduled completion time of each of the model sets comprised in the first category set are calculated based on an operable time of each of the production lines and a production time of each of the model sets in sequence; and
wherein for the second category set, based on a sorted result of each of the model sets, a scheduled start time and a scheduled completion time of each of the model sets comprised in the second category set are calculated based on the operable time of each of the production lines, a production line switching time of switching one model set to another model set and the production time of each of the model sets in sequence.

7. The intelligent scheduling method according to claim 6, wherein step C further comprises a calculation step of a second stage, which comprises:
a solution construction step: in which a combination (j, o, k, l) is determined to perform solution construction for each iteration, wherein the combination (j, o, k, l) indicates a l-th sorted position in which a batch k is sorted in a model set o of a production line j, k∈NBSⱼₒ, j=1, 2, . . . , m, o∈SASⱼ, 1=1,2, . . . ,|NBSⱼₒ|, NBSⱼₒ is a batch set of the model set o of the production line j, m is a total number of the production lines, SASⱼ is a set composed of model set numbers with the same SOP in the production line j;
wherein the solution construction comprises:
a1. calculating a scheduled start time and a scheduled completion time of the batch k;
a2. sorting each of the work orders in the batch k in the non-increasing order according to the corresponding weight;
a3. calculating a scheduled start time and a scheduled completion time of a work order i at each of the sorted positions in the batch k;
a4. defining a work order set that reaches a target production process time;
a5. defining a work order set completed before a target due date;
a6. calculating a total weighted work order completion rate.

8. The intelligent scheduling method according to claim 7, wherein the calculation step of the second stage further comprises:
a pheromone update step: performing a local pheromone update or a global pheromone update based on the total weighted work order completion rate to update a pheromone value; and
an adaptive algorithm step, comprising:
b1. in response to that a current iterative solution is better than a current optimal solution, after replacing the current optimal solution with the current iterative solution and performing the global pheromone update, the solution construction step is executed again until a termination condition is met;
b2. in response to that the current iterative solution is not better than the current optimal solution, and after adding 1 to an accumulated number of iterations, it is determined whether the accumulated number of iterations reaches a threshold value and whether a preset parameter exceeds an upper limit value;
b3. in response to that the accumulated number of iterations does not reach the threshold value or the preset parameter exceeds the upper limit value, after performing the global pheromone update, the solution construction step is executed again until the termination condition is met;
b4. in response to that the accumulated number of iterations reaches the threshold value and the preset parameter has not exceeded the upper limit value, the preset parameter is set higher, the pheromone value is initialized, and the accumulated iteration number returns to 0, the solution construction step is executed again until the termination condition is met.

9. The intelligent scheduling method according to claim 1, wherein the schedule plan comprises a batch scheduling report data and a work order scheduling report data,
the batch schedule report data is provided to assign a scheduled start time and a scheduled completion time corresponding to each batch number in a model set to which each of a production line belongs;
the work order scheduling report data is provided to assign a scheduled start time and a scheduled completion time corresponding to each work order number in each batch number in the model set to which each of the production line belongs.

10. An intelligent scheduling system, comprising:
a storage, which stores a work order assignment module, a work order form batching module, and a work order detailed scheduling module;
an output device; and
a processor, which is coupled to the storage and the output device, and is configured to:
execute the work order assignment module to assign a plurality of work orders to one of a plurality of production lines respectively;
execute the work order form batching module to perform a form batch for the work orders assigned to each of the production lines, the work orders are divided into a plurality of work order groups;
execute the work order detailed scheduling module, solving for each of the work orders comprised in each batch of each of the production lines to obtain a schedule plan, wherein the schedule plan comprises a production line assigned for each of the work orders and an operation sequence; and
transmit the schedule plan to the output device.

11. The intelligent scheduling system according to claim 10, wherein the processor executes the work order assignment module to:
execute an assignment model, which comprises: based on a first objective function, satisfying a plurality of first limiting conditions, assigning each of work orders in a priority work order weight set to one of the production lines, and obtaining a priority work order assignment plan; and
execute a production line switching counts optimization model, which comprises: based on a second objective function, satisfying a plurality of second limiting conditions, limiting a production line switching count of each of the production lines.

12. The intelligent scheduling system according to claim 11, wherein the processor executes a priority weight evaluation model of the work order assignment module to:
based on a third objective function, satisfying a plurality of third limiting conditions, determine whether each of the work orders in the priority work order weight set is assigned to the corresponding production line;
in response to each of the work orders in the priority work order weight set being assigned to the corresponding production line, execute the assignment model; and
in response to at least one of the work orders in the priority work order weight set being unable to be assigned to the corresponding production line, display a feedback information on a user interface.

13. The intelligent scheduling system according to claim 12, wherein the processor is configured to:
re-adjust the priority work order weight set through the user interface, and re-execute the priority weight evaluation model;
wherein the feedback information shows work orders in the priority work order weight set that are unable to be assigned.

14. The intelligent scheduling system according to claim 10, wherein the processor executes the work order form batching module to:
based on a fourth objective function, and satisfying a plurality of fourth limiting conditions, perform form batching for a plurality of work orders among the work orders comprised in a plurality of batches with the same attribute into a work order group based an attribute of each of the work orders.

15. The intelligent scheduling system according to claim 10, wherein the processor executes the work order detailed scheduling module to:
categorize the production lines into a first category set and a second category set, wherein a model set that is assigned into a production line of the first category set does not need to be switched to another production line, a model set assigned to a production line in the second category set needs to be switched to another production line;
the model sets comprised in each of the first category set and the second category set are sorted in a non-increasing sequence based on their own representative weight;
wherein for the first category set, based on a sorted result of each of the model sets, a scheduled start time and a scheduled completion time of each of the model sets comprised in the first category set are calculated based on an operable time of each of the production lines and a production time of each of the model sets in sequence; and
wherein for the second category set, based on a sorted result of each of the model sets, a scheduled start time and a scheduled completion time of each of the model sets comprised in the second category set are calculated based on the operable time of each of the production lines, a production line switching time of switching one model set to another model set and the production time of each of the model sets in sequence.

16. The intelligent scheduling system according to claim 15, wherein the processor executes the work order detailed scheduling module to:
perform a solution construction step, wherein the solution construction step comprises:
determining a combination (j, o, k, l) to perform solution construction for each iteration, wherein the combination (j, o, k, l) indicates a l-th sorted position in which a batch k is sorted in a model set o of a production line j, k∈NBSⱼₒ, j=1, 2, . . . , m, o∈SASⱼ, l=1,2, . . . ,|NBSⱼₒ|, NBSⱼₒ is a batch set of the model set o of the production line j, m is a total number of the production lines, SASⱼ is a set composed of model set numbers with the same SOP in the production line j;
wherein the solution construction comprises:
a1. calculating a scheduled start time and a scheduled completion time of the batch k;
a2. sorting each of the work orders in the batch k in the non-increasing order according to the corresponding weight;
a3. calculating a scheduled start time and a scheduled completion time of a work order i at each of the sorted positions in the batch k;
a4. defining a work order set that reaches a target production process time;
a5. defining a work order set completed before a target due date;
a6. calculating a total weighted work order completion rate.

17. The intelligent scheduling system according to claim 16, wherein the processor executes the work order detailed scheduling module to:
perform a pheromone update step: performing a local pheromone update or a global pheromone update based on the total weighted work order completion rate to update a pheromone value; and
perform an adaptive algorithm step, comprising:
b1. in response to that a current iterative solution is better than a current optimal solution, after replacing the current optimal solution with the current iterative solution and performing the global pheromone update, the solution construction step is executed again until a termination condition is met;
b2. in response to that the current iterative solution is not better than the current optimal solution, and after adding 1 to an accumulated number of iterations, it is determined whether the accumulated number of iterations reaches a threshold value and whether a preset parameter exceeds an upper limit value;
b3. in response to that the accumulated number of iterations does not reach the threshold value or the preset parameter exceeds the upper limit value, after performing the global pheromone update, the solution construction step is executed again until the termination condition is met;
b4. in response to that the accumulated number of iterations reaches the threshold value and the preset parameter has not exceeded the upper limit value, the preset parameter is set higher, the pheromone value is initialized, and the accumulated iteration number returns to 0, the solution construction step is executed again until the termination condition is met.

18. The intelligent scheduling system according to claim 10, wherein the schedule plan comprises a batch scheduling report data and a work order scheduling report data,
the batch schedule report data is provided to assign a scheduled start time and a scheduled completion time corresponding to each batch number in a model set to which each of a production line belongs;
the work order scheduling report data is provided to assign a scheduled start time and a scheduled completion time corresponding to each work order number in each batch number in the model set to which each of the production line belongs.

19. A non-transitory computer-readable recording medium for storing a program code which, when executed by a processor, makes the processor to perform the following:
assigning a plurality of work orders to one of a plurality of production lines respectively through a work order assignment module;
performing a form batch for the work orders assigned to each of the production lines through a work order form batching module, the work orders are divided into a plurality of work order groups;
solving for each of the work orders comprised in each batch of each of the production lines through a work order detailed scheduling module to obtain a schedule plan, wherein the schedule plan comprises a production line assigned for each of the work orders and an operation sequence; and
transmitting the schedule plan to an output device.
